(19) United States
(12) Patent Application Publication
(10) Pub. No.: US 2012/0218236 A1
(43) Pub. Date: Aug. 30, 2012

(54) COMPUTER-READABLE STORAGE MEDIUM HAVING INFORMATION PROCESSING PROGRAM STORED THEREIN, INFORMATION PROCESSING APPARATUS, INFORMATION PROCESSING METHOD, AND INFORMATION PROCESSING SYSTEM

(75) Inventors: Kazuki HIROSE, Kyoto (JP); Tsutomu Araki, Kyoto (JP); Ryutaro Takahashi, Kyoto (JP); Tomohiro Fujii, Kyoto (JP)

(73) Assignee: NINTENDO CO., LTD., Kyoto (JP)

(21) Appl. No.: 13/404,515

(22) Filed: Feb. 24, 2012

(30) Foreign Application Priority Data
Feb. 24, 2011 (JP) 2011-039069

(51) Int. Cl. G09G 5/00

(52) U.S. Cl. 345/204

(57) ABSTRACT

A computer-readable storage medium has stored therein an information processing program executed by a computer of a display control apparatus which displays an image on a display section in either of planar-view display or stereoscopic display. The information processing program causes the computer to operate as: a switching section configured to switch between planar-view display and stereoscopic display; a setter configured to set image display by the display section to a state of being restricted to only the planar-view display or a state of not being restricted to only the planar-view display; and a display controller configured to switch the image display by the display section to the planar-view display or the stereoscopic display in accordance with display setting when it is set to the state of not being restricted to the planar-view display, and causing the display section to perform planar-view display of an image regardless of the display setting which is set by the switching section, when the image display by the display section is set to the state of being restricted to only the planar-view display.

### CROSS REFERENCE TO RELATED APPLICATION

The disclosure of Japanese Patent Application No.2011-39069, filed on Feb. 24, 2011, is incorporated herein by reference.

### FIELD

Embodiments relate to a computer-readable storage medium having an information processing program stored therein, an information processing apparatus, an information processing method, and an information processing system, and more particularly relates to a computer-readable storage medium having an information processing program stored therein, an information processing apparatus, an information processing method, and an information processing system, which can switch a display of an image between a planar-view display and a stereoscopic display.

### BACKGROUND AND SUMMARY

Conventionally, there are apparatuses which display stereoscopically visible images.

However, when display of the stereoscopically visible image (hereinafter, referred to as stereoscopic display) is performed, a user may feel uncomfortable. Specifically, for example, when a user having a great difference in visual power between right and left eyes views an stereoscopically displayed image, the user may visually recognize the image as two images either of which is blurred, not as an image having a stereoscopic effect, and thus may feel uncomfortable. In addition, some specialists have an opinion that when a young user whose vision is at the developmental stage views a stereoscopically visible image, it influences the development of their vision. In other words, among users targeted for stereoscopic display, there may be users who are inappropriate as targets of stereoscopic display.

Therefore, an object of the embodiments is to provide an computer-readable storage medium having an information processing program stored therein, an information processing apparatus, an information processing method, and an information processing system, which can restrict an inappropriate stereoscopic display.

In order to attain the object described above, the embodiments include the following features.

A computer-readable storage medium according to the embodiments has stored therein an information processing program executed by a computer of a display control apparatus which displays an image on a display section in either of planar-view display or stereoscopic display. The information processing program causes the computer to operate as a switching section, a setter, and a display controller. The switching section is configured to switch a display setting which is a setting of whether to perform planar-view display or stereoscopic display by the display section, in accordance with an operation of a user. The setter is configured to set image display by the display section to a state of being restricted to the planar-view display or a state of not being restricted to the planar-view display. The display controller is configured to switch the image display by the display section to the planar-view display or the stereoscopic display in accordance with the display setting which is set by the switching section, when the image display by the display section is set to the state of not being restricted to the planar-view display, and to cause the display section to perform planar-view display of an image regardless of the display setting which is set by the switching section, when the image display by the display section is set to the state of being restricted to only the planar-view display.

According to the above configuration example, when not being restricted, either one of the stereoscopic display or the planar-view display can be selected according to preference, and when restriction to only the planar-view display is set by the computer, the display by the display section can be restricted to the planar-view display to prevent inappropriate stereoscopic display.

In another configuration example, the information processing program may further cause the computer to operate as an input operation receiver. The input operation receiver is configured to receive an operation input of the user via an input section. In such a case, when an operation input which satisfies a predetermined condition is received by the input operation receiver, the setter may set the image display by the display section to the state of not being restricted to only the planar-view display.

According to the above configuration example, the stereoscopic display can be performed only for a specific user who knows a predetermined input condition. For example, if a user who sets restriction to the planar-view display tells the predetermined input condition to a specific user for whom stereoscopic display is determined as not being inappropriate, only the specific user can be authenticated and the stereoscopic display can be performed for the specific user.

In another configuration example, the information processing program may be an information processing program which causes the display section to display an image which is generated by executing an application program which causes the computer to operate as an image generator configured to generate the image which is either a stereoscopic image which is stereoscopically viewable or a planar image which is not stereoscopically viewable. In such a case, when the image display by the display section is set by the setter to the state of being restricted to only the planar-view display, the display controller may restrict display of the image, which is generated by the image generator, by the display section, to the planar-view display regardless of the display setting by the switching section.

According to the above configuration example, displays of images, which are generated by the image generator, by the display section can be collectively and compulsorily restricted by the information processing program. Therefore, the producer of the application program can produce the application program in a shorter time without considering restriction of stereoscopic display.

In another configuration example, the information processing program may be an information processing program which causes the display section to display an image in accordance with a setting operation received by executing a setting operation reception program which causes the computer to operate as a receiver configured to receive, from the user, the setting operation for setting the image display by the display section to a state of being restricted to the planar-view display or a state of not being restricted to the planar-view display. In such a case, the switching section may be capable of switching the display setting at all times. In addition, the setter may set the image display by the display section to the state of being restricted to the planar-view display or the state of not being restricted to the planar-view display, in accordance with the setting operation received by the receiver.

According to the above configuration example, even when the display setting is switched by the switching section as needed, the display controller can cause the display section to perform planar-view display of an image in preference to setting by a setting operation received by the setting operation reception program (a game apparatus setting program).

In another configuration example, the switching section may switch the display setting in accordance with an operation of the user on a mechanical switch.

According to the above configuration example, even when the user operates the mechanical switch to switch the display setting, the display controller can cause the display section to perform planar-view display of an image in preference to setting by a setting operation received by the setting operation reception program.

In another configuration example, the image generator may generate the stereoscopic image by using setting information indicating information for setting virtual cameras for taking the stereoscopic image composed of two images; when the image display by the display section is set by the setter to the state of being restricted to only the planar-view display, the display controller may generate the setting information for performing setting such that same images are generated by using the virtual cameras for taking the two images, respectively, regardless of the display setting by the switching section; and the image generator may generate the stereoscopic image composed of the same images, by using the setting information generated by the display controller.

According to the above configuration example, when restriction to the planar-view display is set, the display controller generates setting information indicating the same viewpoint, as setting information of the virtual cameras used by the image generator to generate the stereoscopic image. Thus, two images generated as a stereoscopic image by the image generator become planar images which are taken from the same viewpoint, do not have a disparity, and are not stereoscopically viewable. In other words, the image generator performs a process which is to be performed when the display mode is set to a planar display mode. Thus, when restriction to only the planar-view display is set, the display controller can restrict display of an image, which is generated by the image generator, by the display section to the planar-view display.

In another configuration example, the image generator may generate the stereoscopic image as two images having a disparity, and when the image display by the display section is set by the setter to the state of being restricted to only the planar-view display, the display controller may cause the display section to display only either one of the two images generated as the stereoscopic image.

According to the above configuration example, even when two images having a disparity are generated as a stereoscopic image by the image generator despite it is restricted to the planar-view display, the display controller cause the display section to display either one of the images as a single image which does not have a disparity and is not stereoscopically viewable, thereby achieving restriction to the planar-view display.

In another configuration example, when two images having a disparity are generated as the stereoscopic image, the image generator may generate images taken with left and right virtual cameras which are located in a virtual space at an interval corresponding to the disparity, and when the image display by the display section is set by the setter to the state of being restricted to only the planar-view display, the display controller may cause the display section to display the image taken with either one of the virtual cameras, among the two images generated as the stereoscopic image by using the left and right virtual cameras.

According to the above configuration example, when the image generator uses the two virtual cameras to generate two images having a disparity as a stereoscopic image, the display controller causes the display section to display only an image taken with either one of the virtual cameras, thereby achieving restriction to the planar-view display.

In another configuration example, the image generator may generate the stereoscopic image by using instruction information based on at least an instruction value from an instruction section configured to instruct a stereoscopic degree at which the user visually recognizes a stereoscopic display object indicated by the stereoscopic image, as being stereoscopic.

According to the above configuration example, the image generator can generate a stereoscopic image having a stereoscopic degree corresponding to a value outputted from the instruction section.

In another configuration example, the image generator may generate setting information for generating the stereoscopic image. In such a case, the information processing program further causes the computer to operate as an instruction value receiver. The instruction value receiver is configured to receive the instruction value outputted from the instruction section. In addition, in such a case, the display controller may generate the instruction information on the basis of the setting information and the instruction value received by the instruction value receiver.

According to the above configuration example, the display controller calculates the instruction information needed for generating the stereoscopic image, on the basis of the instruction value outputted from the instruction section and the setting information obtained from the image generator. Thus, an adjustment result of the instruction value by the instruction section can be prevented from being varied between different applications.

In another configuration example, when two images having a disparity are generated as the stereoscopic image, the image generator may generate images taken with left and right virtual cameras which are located in a virtual space at an interval corresponding to the disparity, and when the image display by the display section is set by the setter to the state of being restricted to only the planar-view display, the display controller may generate the instruction information including information for setting the interval between the left and right virtual cameras to zero, on the basis of the setting information and the instruction value which is outputted from the instruction section and converted so as to indicate a stereoscopic degree of zero.

According to the above configuration example, if it is restricted to the planar-view display when a stereoscopic image is generated by using the two virtual cameras on the basis of the instruction information, the interval between the two virtual cameras is set to zero, and same images are generated by the image generator, thereby achieving restriction to the planar-view display.

In another configuration example, the image generator may generate the stereoscopic image in accordance with the instruction information based on at least the instruction value outputted from the instruction section which enables an analog input.

According to the above configuration example, since an input of an instruction value is received via the instruction section which enables an analog input, the user can finely adjust the instruction value through a sense of touch without viewing the instruction section.

In another configuration example, the information processing program may be an information processing program which causes the display section to display an image which is generated by executing an application program which causes the computer to operate as image generator configured to generate the image which is either a stereoscopic image which is stereoscopically viewable or a planar image which is not stereoscopically viewable. In such a case, when the image display by the display section is set by the setter to the state of being restricted to only the planar-view display, the input operation receiver may receive an operation input of the user when execution of the application program is started. The information processing program may further cause the computer to operate as: a release section configured to release the setting of the image display by the display section to the state of being restricted to only the planar-view display, which setting is performed by the setter, when an operation input which satisfies the predetermined condition is received by the input operation receiver; and a restriction returning section configured to return the setting released by the release section, when the execution of the application program ends.

According to the above configuration example, even when restriction to the planar-view display is set, if the user makes an input which satisfies the predetermined condition when the user executes the application program, the restriction can be released and stereoscopic display can be performed. For example, if a user who sets restriction to the planar-view display tells the predetermined condition to a specific user for whom stereoscopic display is determined as not being inappropriate, only the specific user can be authenticated and stereoscopic display can be performed for the specific user. In addition, when the application program ends, restriction of an image to the planar-view display is automatically restarted, and release of the restriction can be temporary.

In another configuration example, the information processing program may be an information processing program which causes the display section to display a stereoscopic image which is generated by executing an application program which causes the computer to operate as image generator configured to generate the stereoscopic image by generating stereoscopic degree information indicating a stereoscopic degree at which the user visually recognizes a stereoscopic display object indicated by the stereoscopic image which is stereoscopically viewable, as being stereoscopic. In such a case, the information processing program may further cause the computer to operate as a setting information generator. The setting information generator is configured to generate setting information needed for generating the stereoscopic image by the image generator, on the basis of the stereoscopic degree information. In addition, in such a case, the image generator may generate the stereoscopic image by using the setting information.

According to the above configuration example, the system program can calculate an instruction parameter needed for generating a stereoscopic image, in accordance with a stereoscopic degree required when the image generator generates a stereoscopic image. Thus, the stereoscopic degrees of stereoscopic images generated by different applications can be made uniform.

In another configuration example, the information processing program may further cause the computer to operate as a notification controller. The notification controller is configured to control a notification section configured to notify that stereoscopic display by the display section is enabled. When the image display by the display section is set by the setter to the state of being restricted to only the planar-view display, the notification controller may stop notification by the notification section regardless of whether or not the stereoscopic display is enabled, and when the image display by the display section is set by the setter to the state of not being restricted to only the planar-view display, the notification controller may cause the notification section to perform notification if the stereoscopic display is enabled.

According to the above configuration example, when the display of the display section is restricted to the planar-view display, even a state where the stereoscopic display is enabled, such as two images having a disparity being generated by the application program, is not notified of. Thus, notification corresponding to restriction can be realized.

In another configuration example, the information processing program may further cause the computer to operate as a parallax barrier controller. The parallax barrier controller is configured to turn off a parallax barrier used by the display section for performing stereoscopic display, when the image display by the display section is set by the setter to the state of being restricted to only the planar-view display.

According to the above configuration example, when the display section is caused to perform planar-view display, if the parallax barrier is turned off, the brightness of an image which is viewed by the user can be maintained even when the brightness of a backlight is decreased. Therefore, by turning off the parallax barrier when the display section is caused to perform planar-view display, the brightness of the backlight can be decreased to reduce power consumption.

Further, the embodiments may be implemented in the form of a display control apparatus or a display control system including the above respective sections, or in the form of a display control method including actions performed by the above respective sections.

According to the embodiments, a computer-readable storage medium having an information processing program stored therein, an information processing apparatus, an information processing method, and an information processing system, which can restrict inappropriate stereoscopic display, can be provided.

### BRIEF DESCRIPTION OF THE DRAWINGS

FIG. 1 is a front view of a game apparatus 10 in an opened state;

FIG. 2 is a side view of the game apparatus 10 in the opened state;

FIG. 3 is an A-A′ line cross-sectional view of an upper housing 21 shown in FIG. 1;

FIG. 4A is a diagram illustrating a state in which a slider 25a of a 3D adjustment switch 25 is positioned at a lowermost position (a third position);

FIG. 4B is a diagram illustrating a state in which the slider 25a of the 3D adjustment switch 25 is positioned above the lowermost position (a first position);

FIG. 4C is a diagram illustrating a state in which the slider 25a of the 3D adjustment switch 25 is positioned at an uppermost position (a second position);

FIG. 5 is a block diagram illustrating an internal configuration of the game apparatus 10;

FIG. 6 is a diagram illustrating an example of a memory map;

FIG. 7 is a diagram illustrating an example of a memory map;

FIG. 8 is a diagram illustrating an example of a memory map;

FIG. 9 is a flowchart showing an example of a system process in an embodiment;

FIG. 10 is a flowchart showing an example of a launcher process in the embodiment; and

FIG. 11 is a flowchart showing an example of a game apparatus setting process in the embodiment.

### DETAILED DESCRIPTION OF NON-LIMITING EXAMPLE EMBODIMENTS

### First Embodiment

[Structure of Game Apparatus]

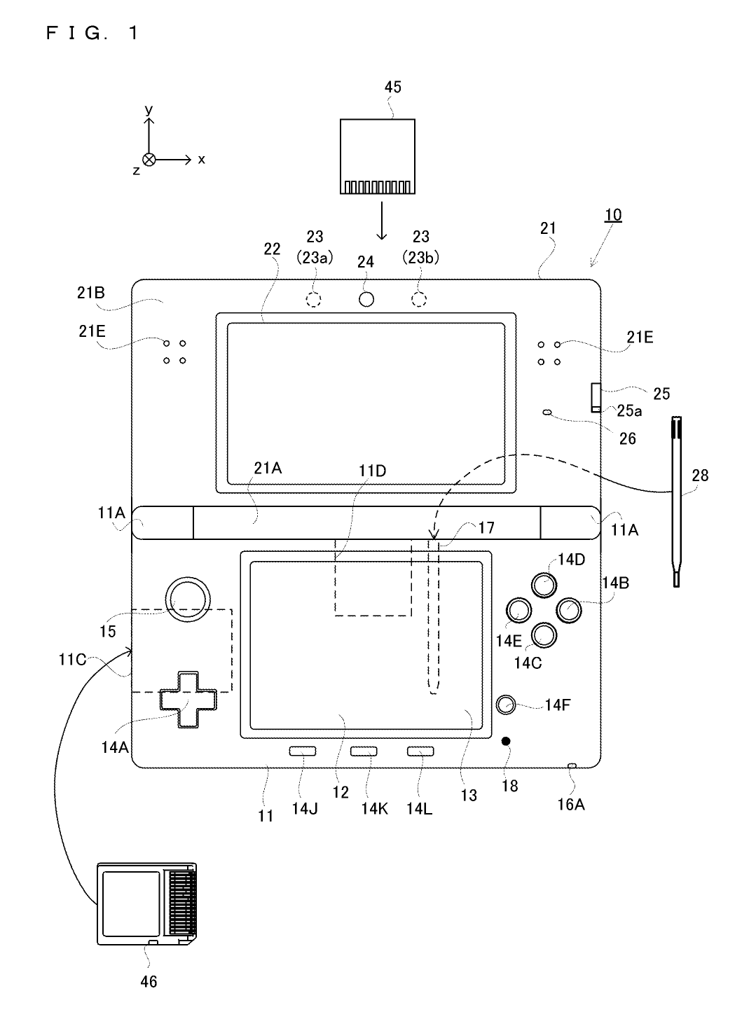

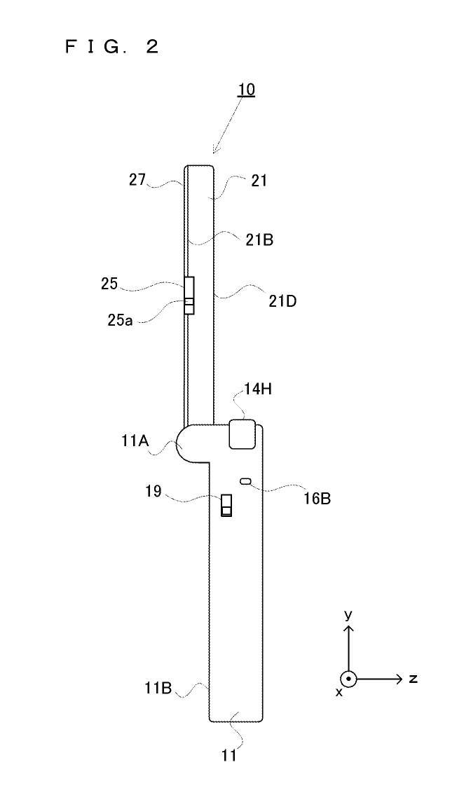

Hereinafter, a game apparatus according to an embodiment (hereinafter, referred to as first embodiment) will be described. FIGS. 1 and 2 are plan views of the appearance of a game apparatus 10. The game apparatus 10 is a hand-held game apparatus. FIGS. 1 and 2 show the game apparatus 10 in an opened state. FIG. 1 is a front view of the game apparatus 10 in the opened state, and FIG. 2 is a right side view of the game apparatus 10 in the opened state. The game apparatus 10 is able to take an image by means of an imaging section, display the taken image on a screen, and store data of the taken image. The game apparatus 10 can execute a game program which is stored in an exchangeable memory card or a game program which is received from a server or another game apparatus, and can display, on the screen, an image generated by computer graphics processing, such as an image taken by a virtual camera set in a virtual space, for example.

Initially, an external structure of the game apparatus 10 will be described with reference to FIGS. 1 and 2. The game apparatus 10 includes a lower housing 11 and an upper housing 21 as shown in FIGS. 1 and 2. The lower housing 11 and the upper housing 21 are connected to each other so as to be openable and closable (foldable).

[Description of Lower Housing]

Initially, a structure of the lower housing 11 will be described. As shown in FIGS. 1 and 2, in the lower housing 11, a lower LCD (Liquid Crystal Display) 12, a touch panel 13, operation buttons 14A to 14L, an analog stick 15, an LED 16A and an LED 16B, an insertion opening 17, and a microphone hole 18 are provided. Hereinafter, these components will be described in detail.

As shown in FIG. 1, the lower LCD 12 is accommodated in the lower housing 11. The number of pixels of the lower LCD 12 may be, for example, 320 dots×240 dots (the longitudinal line×the vertical line). The lower LCD 12 is a display device for displaying an image in a planar manner (not in a stereoscopically visible manner), which is different from the upper LCD 22 as described below. Although an LCD is used as a display device in the present embodiment, any other display device such as a display device using an EL (Electro Luminescence), or the like may be used. In addition, a display device having any resolution may be used as the lower LCD 12.

As shown in FIG. 1, the game apparatus 10 includes the touch panel 13 as an input device. The touch panel 13 is mounted on the screen of the lower LCD 12. In the present embodiment, the touch panel 13 may be, but is not limited to, a resistive film type touch panel. A touch panel of any type such as electrostatic capacitance type may be used. In the present embodiment, the touch panel 13 has the same resolution (detection accuracy) as that of the lower LCD 12. However, the resolution of the touch panel 13 and the resolution of the lower LCD 12 may not necessarily be the same. Further, the insertion opening 17 (indicated by dashed line in FIG. 1) is provided on the upper side surface of the lower housing 11. The insertion opening 17 is used for accommodating a touch pen 28 which is used for performing an operation on the touch panel 13. Although an input on the touch panel 13 is usually made by using the touch pen 28, a finger of a user may be used for making an input on the touch panel 13, in addition to the touch pen 28.

The operation buttons 14A to 14L are each an input device for making a predetermined input. As shown in FIG. 1, among operation buttons 14A to 14L, a cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11. The cross button 14A is cross-shaped, and includes buttons for indicating an upward, a downward, a leftward, or a rightward direction. The button 14A to 14E, the selection button 14J, the HOME button 14K, and the start button 14L are assigned functions, respectively, in accordance with a program executed by the game apparatus 10, according to need. For example, the cross button 14A is used for selection operation and the like, and the operation buttons 14B to 14E are used for, for example, determination operation and cancellation operation. The power button 14F is used for powering the game apparatus 10 on/off.

The analog stick 15 is a device for indicating a direction. The analog stick 15 has a top, corresponding to a key, which slides parallel to the inner side surface of the lower housing 11. The analog stick 15 acts in accordance with a program executed by the game apparatus 10. For example, when a game in which a predetermined object appears in a three-dimensional virtual space is executed by the game apparatus 10, the analog stick 15 acts as an input device for moving the predetermined object in the three-dimensional virtual space. In this case, the predetermined object is moved in a direction in which the top corresponding to the key of the analog stick 15 slides. As the analog stick 15, a component which enables an analog input by being tilted by a predetermined amount, in any direction, such as the upward, the downward, the rightward, the leftward, or the diagonal direction, may be used.

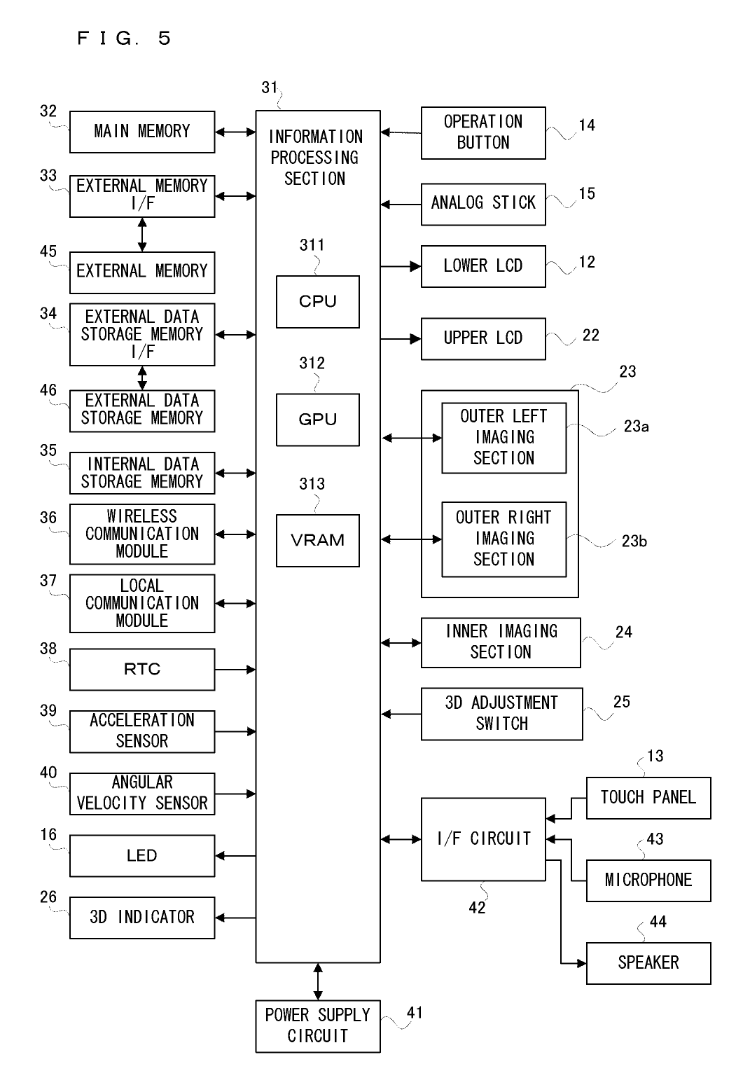

Further, the microphone hole 18 is provided on the inner side surface of the lower housing 11. Under the microphone hole 18, a microphone (see FIG. 5) is provided as a sound input device described below, and the microphone detects for a sound from the outside of the game apparatus 10.

Further, the R button 14H is provided on the right end portion of the upper side surface of the lower housing 11 as shown in FIG. 2. Moreover, the L button 14G is provided on the left end portion of the upper side surface of the lower housing 11, although not shown. The L button 14G and the R button 14H can act as, for example, shutter buttons (imaging instruction buttons) of the imaging section. Further, a sound volume button 14I (not shown) is provided on the left side surface of the lower housing 11. The sound volume button 14I is used for adjusting a sound volume of a speaker of the game apparatus 10.

As shown by a dashed line in FIG. 1, an insertion opening 11C is provided in the left side surface of the lower housing 11 so as to be covered with a cover section. Inside the insertion opening 11C, a connector (not shown) is provided for electrically connecting between the game apparatus 10 and an external data storage memory 46. The external data storage memory 46 is detachably connected to the connector. The external data storage memory 46 is used for, for example, recording (storing) data of an image taken by the game apparatus 10.

Further, as shown by a dashed line in FIG. 1, an insertion opening 11D through which an external memory 45 having a game program stored therein is inserted is provided in the upper side surface of the lower housing 11. A connector (not shown) for electrically connecting between the game apparatus 10 and the external memory 45 in a detachable manner is provided inside the insertion opening 11D. A predetermined game program is executed by connecting the external memory 45 to the game apparatus 10.

Further, as shown in FIG. 1, a first LED 16A for notifying a user of an ON/OFF state of a power supply of the game apparatus 10 is provided on the lower side surface of the lower housing 11. Although not shown, a second LED 16B for notifying a user of an establishment state of a wireless communication of the game apparatus 10 is provided on the right side surface of the lower housing 11. The game apparatus 10 can make wireless communication with other devices, and the second LED 16B is lit up when the wireless communication is established. The game apparatus 10 has a function of connecting to a wireless LAN in a method based on, for example, IEEE802.11b/g standard. A wireless switch 19 for enabling/disabling the function of the wireless communication is provided on the right side surface of the lower housing 11 (see FIG. 2).

Although not shown, a rechargeable battery acting as a power supply for the game apparatus 10 is accommodated in the lower housing 11. The battery can be charged through a terminal provided on a side surface (for example, the upper side surface) of the lower housing 11.

[Description of Upper Housing]

Next, a structure of the upper housing 21 will be described. As shown in FIGS. 1 and 2, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided. Hereinafter, theses components will be described in detail.

As shown in FIG. 1, the upper LCD 22 is accommodated in the upper housing 21. The number of pixels of the upper LCD 22 may be, for example, 800 dots×240 dots (the horizontal line×the vertical line). Although, in the present embodiment, the upper LCD 22 is an LCD, a display device using an EL (Electro Luminescence), or the like may be used. In addition, a display device having any resolution may be used as the upper LCD 22.

The upper LCD 22 is a display device capable of displaying a stereoscopically visible image. Further, in the present embodiment, an image for a left eye and an image for a right eye are displayed by using substantially the same display area. Specifically, the upper LCD 22 may be a display device using a method in which the image for a left eye and the image for a right eye are alternately displayed in the horizontal direction in predetermined units (for example, every other line). Alternatively, a display device using a method in which the image for a left eye and the image for a right eye are alternately displayed in a time division manner may be used. Further, in the present embodiment, the upper LCD 22 is a display device capable of displaying an image which is stereoscopically visible with naked eyes. A lenticular lens type display device or a parallax barrier type display device is used which enables the image for a left eye and the image for a right eye, which are alternately displayed in the horizontal direction, to be separately viewed by the left eye and the right eye, respectively. In the present embodiment, the upper LCD 22 of a parallax barrier type is used. The upper LCD 22 displays, by using the image for a right eye and the image for a left eye, an image (a stereoscopic image) which is stereoscopically visible with naked eyes. That is, the upper LCD 22 allows a user to view the image for a left eye with her/his left eye, and the image for a right eye with her/his right eye by utilizing a parallax barrier, so that a stereoscopic image (a stereoscopically visible image) exerting a stereoscopic effect for a user can be displayed. Further, the upper LCD 22 may disable the parallax barrier. When the parallax barrier is disabled, an image can be displayed in a planar manner (it is possible to display a planar visible image which is different from a stereoscopically visible image as described above. Specifically, a display mode is used in which the same displayed image is viewed with a left eye and a right eye.). Thus, the upper LCD 22 is a display device capable of switching between a stereoscopic display mode for displaying a stereoscopically visible image and a planar display mode (for displaying a planar visible image) for displaying an image in a planar manner. The switching of the display mode is performed by the 3D adjustment switch 25 described below.

Two imaging sections (an outer imaging section (left) 23a and an outer imaging section (right) 23b) provided on the outer side surface (the back surface reverse of the main surface on which the upper LCD 22 is provided) 21D of the upper housing 21 are generically referred to as the outer imaging section 23. The imaging directions of the outer imaging section (left) 23a and the outer imaging section (right) 23b are each the same as the outward normal direction of the outer side surface 21D. The outer imaging section (left) 23a and the outer imaging section (right) 23b can be used as a stereo camera depending on a program executed by the game apparatus 10. Each of the outer imaging section (left) 23a and the outer imaging section (right) 23b includes an imaging device, such as a CCD image sensor or a CMOS image sensor, having a common predetermined resolution, and a lens. The lens may have a zooming mechanism.

As indicated by dashed lines in FIG. 1, the outer imaging section (left) 23a and the outer imaging section (right) 23b forming the outer imaging section 23 are aligned so as to be parallel to the horizontal direction of the screen of the upper LCD 22. Specifically, the outer imaging section (left) 23a and the outer imaging section (right) 23b are positioned such that a straight line connecting between the two imaging sections is parallel to the horizontal direction of the screen of the upper LCD 22. Reference numerals 23a and 23b which are indicated as dashed lines in FIG. 1 represent the outer imaging section (left) 23a and the outer imaging section (right) 23b, respectively, which are positioned on the outer side surface reverse of the inner side surface of the upper housing 21. As shown in FIG. 1, when a user views the screen of the upper LCD 22 from the front thereof, the outer imaging section (left) 23a is positioned to the left of the upper LCD 22 and the outer imaging section (right) 23b is positioned to the right of the upper LCD 22. When a program for causing the outer imaging section 23 to function as a stereo camera is executed, the outer imaging section (left) 23a takes an image for a left eye, which is viewed by a left eye of a user, and the outer imaging section (right) 23b takes an image for a right eye, which is viewed by a right eye of the user. The interval between the outer imaging section (left) 23a and the outer imaging section (right) 23b is set so as to be approximately the same as the interval between both eyes of a person, that is, may be set so as to be within a range from 30 mm to 70 mm, for example, However, the interval between the outer imaging section (left) 23a and the outer imaging section (right) 23b is not limited to a distance within the range described above.

The 3D adjustment switch 25 is a slide switch, and is used for switching a display mode of the upper LCD 22 as described above. Further, the 3D adjustment switch 25 is used for adjusting the stereoscopic effect of a stereoscopically visible image (stereoscopic image) which is displayed on the upper LCD 22. As shown in FIGS. 1 and 2, the 3D adjustment switch 25 is provided at the end portions of the inner side surface and the right side surface of the upper housing 21, and is positioned at a position at which the 3D adjustment switch 25 is visible to a user when the user views the upper LCD 22 from the front thereof. Further, an operation section of the 3D adjustment switch 25 projects on the inner side surface and the right side surface, and can be viewed and operated from both sides. All the switches other than the 3D adjustment switch 25 are provided on the lower housing 11.

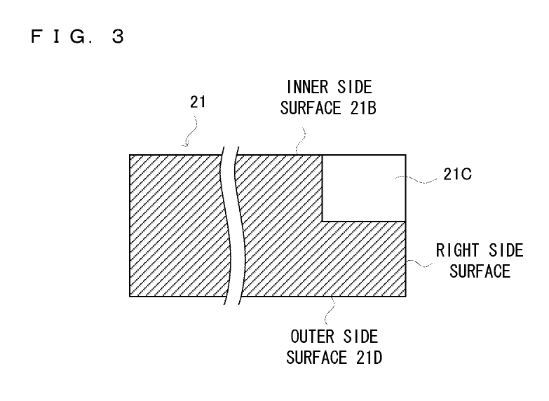

FIG. 3 is an A-A′ line cross-sectional view of the upper housing 21 shown in FIG. 1. As shown in FIG. 3, a recessed portion 21C is formed at the right end portion of the inner side surface of the upper housing 21, and the 3D adjustment switch 25 is provided in the recessed portion 21C. The 3D adjustment switch 25 is provided so as to be visible from the front surface and the right side surface of the upper housing 21 as shown in FIG. 1 and FIG. 2. A slider 25a of the 3D adjustment switch 25 is slidable to any position in a predetermined direction (along the longitudinal direction of the right side surface), and a display mode of the upper LCD 22 is determined in accordance with the position of the slider 25a.

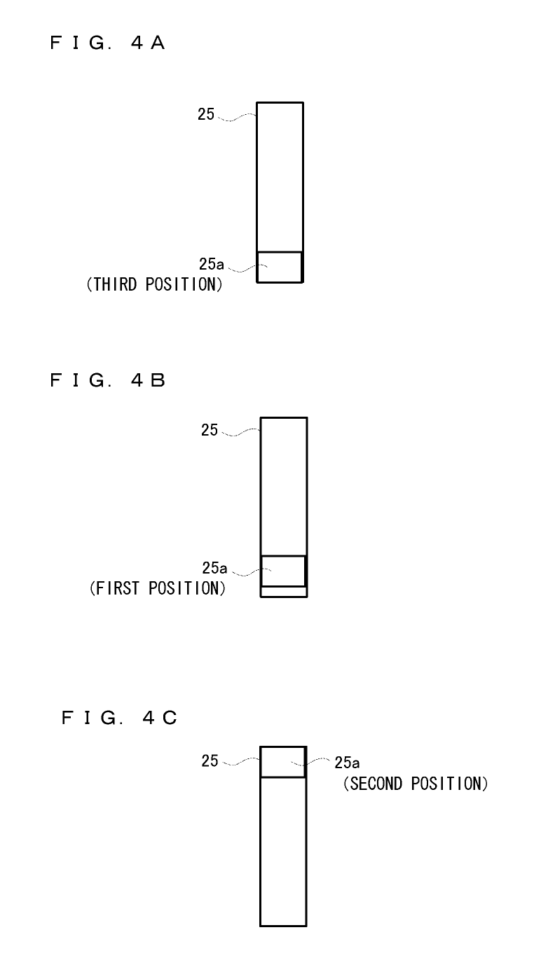

FIGS. 4A to 4C are each a diagram illustrating a state in which the slider 25a of the 3D adjustment switch 25 slides. FIG. 4A is a diagram illustrating a state in which the slider 25a of the 3D adjustment switch 25 is positioned at the lowermost position (a third position). FIG. 4B is a diagram illustrating a state in which the slider 25a of the 3D adjustment switch 25 is positioned above the lowermost position (a first position). FIG. 4C is a diagram illustrating a state in which the slider 25a of the 3D adjustment switch 25 is positioned at the uppermost position (a second position).

As shown in FIG. 4A, when the slider 25a of the 3D adjustment switch 25 is positioned at the lowermost position (the third position), the upper LCD 22 is set to the planar display mode, and a planar image is displayed on the screen of the upper LCD 22 (the upper LCD 22 may remain set to the stereoscopic display mode, and the same image may be used for the image for a left eye and the image for a right eye, to perform planar-view display). On the other hand, when the slider 25a is positioned between a position shown in FIG. 4B (a position (first position) above the lowermost position) and a position shown in FIG. 4C (the uppermost position (the second position)), the upper LCD 22 is set to the stereoscopic display mode. In this case, a stereoscopically visible image is displayed on the screen of the upper LCD 22. When the slider 25a is positioned between the first position and the second position, a manner in which the stereoscopic image is visible is adjusted in accordance with the position of the slider 25a. Specifically, an amount of deviation in the horizontal direction between a position of an image for a right eye and a position of an image for a left eye is adjusted in accordance with the position of the slider 25a. The slider 25a of the 3D adjustment switch 25 is configured so as to be fixed at the third position, and is slidable, along the longitudinal direction of the right side surface, to any position between the first position and the second position. In other words, when the slider 25a is positioned between the first position and the second position, the 3D adjustment switch 25 acts as a device which can output an analog value corresponding to the position of the slider 25a. Further, the slider 25a is fixed at the third position by a projection (not shown) which projects, from the side surface of the 3D adjustment switch 25, in the lateral direction shown in FIG. 4A, and does not slide upward from the third position unless a predetermined force or a force greater than the predetermined force is applied upward. When the slider 25a is positioned between the third position and the first position, the manner in which the stereoscopic image is visible is not adjusted, which is intended as a margin. In another embodiment, the third position and the first position may be the same position, and, in this case, no margin is provided. Further, the third position may be provided between the first position and the second position. In this case, a direction in which an amount of deviation in the horizontal direction between a position of an image for a right eye and a position of an image for a left eye is adjusted when the slider is moved from the third position toward the first position, is opposite to a direction in which an amount of deviation in the horizontal direction between the position of the image for the right eye and the position of the image for the left eye is adjusted when the slider is moved from the third position toward the second position.

It is noted that the 3D adjustment switch 25 can perform switching between a planar display mode and a stereoscopic display mode regardless of setting of later-described display mode restriction, or setting of adjustment of a stereoscopic effect. However, as will be described later, in the present embodiment, setting of the later-described display mode restriction is prioritized over switching or setting by the 3D adjustment switch 25. In addition, in another embodiment, any mechanical switch other than the slide switch, such as a rotary dial switch which can rotates an pointing position from the first position to the third position, may be used as the 3D adjustment switch 25.

The 3D indicator 26 indicates whether or not the upper LCD 22 is in the stereoscopic display mode. The 3D indicator 26 is implemented as a LED, and is lit up when the stereoscopic display mode of the upper LCD 22 is enabled. The 3D indicator 26 may be lit up only when the program processing for displaying a stereoscopic image is performed (namely, image processing in which an image for a left eye is different from an image for a right eye is performed in the case of the 3D adjustment switch 25 being positioned between the first position and the second position) in a state where the upper LCD 22 is in the stereoscopic display mode. As shown in FIG. 1, the 3D indicator 26 is positioned near the screen of the upper LCD 22 on the inner side surface of the upper housing 21. Therefore, when a user views the screen of the upper LCD 22 from the front thereof, the user can easily view the 3D indicator 26. Therefore, also when a user is viewing the screen of the upper LCD 22, the user can easily recognize the display mode of the upper LCD 22.

Further, a speaker hole 21E is provided on the inner side surface of the upper housing 21. A sound is outputted through the speaker hole 21E from a speaker 44 described below.

[Internal Configuration of Game Apparatus]

Next, an internal electrical configuration of the game apparatus 10 will be described with reference to FIG. 5. FIG. 5 is a block diagram illustrating an internal configuration of the game apparatus 10. As shown in FIG. 5, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local communication module 37, a real-time clock (RTC) 38, an acceleration sensor 39, an angular velocity sensor 40, a power supply circuit 41, an interface circuit (I/F circuit) 42, and the like. These electronic components are mounted on an electronic circuit substrate, and accommodated in the lower housing 11 (or the upper housing 21).

The information processing section 31 is information processing means which includes a CPU (Central Processing Unit) 311 for executing a predetermined program, a GPU (Graphics Processing Unit) 312 for performing image processing, and the like. By executing a program stored in a memory (for example, the external memory 45 connected to the external memory I/F 33 or the internal data storage memory 35) inside the game apparatus 10, the CPU 311 of the information processing section 31 executes a process corresponding to the program. The program executed by the CPU 311 of the information processing section 31 may be acquired from another device through communication with the other device. The information processing section 31 further includes a VRAM (Video RAM) 313. The GPU 312 of the information processing section 31 generates an image in accordance with an instruction from the CPU 311 of the information processing section 31, and renders the image in the VRAM 313. The GPU 312 of the information processing section 31 outputs the image rendered in the VRAM 313, to the upper LCD 22 and/or the lower LCD 12, and the image is displayed on the upper LCD 22 and/or the lower LCD 12.

To the information processing section 31, the main memory 32, the external memory I/F 33, the external data storage memory I/F 34, and the internal data storage memory 35 are connected. The external memory I/F 33 is an interface for detachably connecting to the external memory 45. The external data storage memory I/F 34 is an interface for detachably connecting to the external data storage memory 46.

The main memory 32 is volatile storage means used as a work area and a buffer area for (the CPU 311 of) the information processing section 31. That is, the main memory 32 temporarily stores various types of data used for the process based on the above program, and temporarily stores a program acquired from the outside (the external memory 45, another device, or the like), for example. In the present embodiment, for example, a PSRAM (Pseudo-SRAM) is used as the main memory 32.

The external memory 45 is nonvolatile storage means for storing a program executed by the information processing section 31. The external memory 45 is implemented as, for example, a read-only semiconductor memory. When the external memory 45 is connected to the external memory I/F 33, the information processing section 31 can load a program stored in the external memory 45. A predetermined process is performed by the program loaded by the information processing section 31 being executed. The external data storage memory 46 is implemented as a non-volatile readable and writable memory (for example, a NAND flash memory), and is used for storing predetermined data. For example, images taken by the outer imaging section 23 and/or images taken by another device are stored in the external data storage memory 46. When the external data storage memory 46 is connected to the external data storage memory I/F 34, the information processing section 31 loads an image stored in the external data storage memory 46, and the image can be displayed on the upper LCD 22 and/or the lower LCD 12.

The internal data storage memory 35 is implemented as a non-volatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of connecting to a wireless LAN by using a method based on, for example, IEEE 802.11.b/g standard. The local communication module 37 has a function of performing wireless communication with the same type of game apparatus in a predetermined communication method (for example, communication based on a unique protocol or infrared communication). The wireless communication module 36 and the local communication module 37 are connected to the information processing section 31. The information processing section 31 can perform data transmission to and data reception from another device via the Internet by using the wireless communication module 36, and can perform data transmission to and data reception from the same type of another game apparatus by using the local communication module 37.

The acceleration sensor 39 is connected to the information processing section 31. The acceleration sensor 39 detects magnitudes of accelerations (linear accelerations) in the directions of the straight lines along the three axial (xyz axial) directions, respectively. The acceleration sensor 39 is provided inside the lower housing 11. In the acceleration sensor 39, as shown in FIG. 1, the long side direction of the lower housing 11 is defined as x axial direction, the short side direction of the lower housing 11 is defined as y axial direction, and the direction orthogonal to the inner side surface (main surface) of the lower housing 11 is defined as z axial direction, thereby detecting magnitudes of the linear accelerations for the respective axes. The acceleration sensor 39 is, for example, an electrostatic capacitance type acceleration sensor. However, another type of acceleration sensor may be used. The acceleration sensor 39 may be an acceleration sensor for detecting a magnitude of an acceleration for one axial direction or two-axial directions. The information processing section 31 can receive data (acceleration data) representing accelerations detected by the acceleration sensor 39, and detect an orientation and a motion of the game apparatus 10.

The RTC 38 and the power supply circuit 41 are connected to the information processing section 31. The RTC 38 counts time, and outputs the time to the information processing section 31. The information processing section 31 calculates a current time (date) based on the time counted by the RTC 38. The power supply circuit 41 controls power from the power supply (the rechargeable battery accommodated in the lower housing 11 as described above) of the game apparatus 10, and supplies power to each component of the game apparatus 10.

The I/F circuit 42 is connected to the information processing section 31. The microphone 43 and the speaker 44 are connected to the I/F circuit 42. Specifically, the speaker 44 is connected to the I/F circuit 42 through an amplifier which is not shown. The microphone 43 detects a voice from a user, and outputs a sound signal to the I/F circuit 42. The amplifier amplifies a sound signal outputted from the I/F circuit 42, and a sound is outputted from the speaker 44. The touch panel 13 is connected to the I/F circuit 42. The I/F circuit 42 includes a sound control circuit for controlling the microphone 43 and the speaker 44 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The touch position data represents a coordinate of a position, on an input surface of the touch panel 13, on which an input is made. The touch panel control circuit reads a signal outputted from the touch panel 13, and generates the touch position data every predetermined time. The information processing section 31 acquires the touch position data, to recognize a position on which an input is made on the touch panel 13.

The operation button 14 includes the operation buttons 14A to 14L described above, and is connected to the information processing section 31. Operation data representing an input state of each of the operation buttons 14A to 14L is outputted from the operation button 14 to the information processing section 31, and the input state indicates whether or not each of the operation buttons 14A to 14I has been pressed. The information processing section 31 acquires the operation data from the operation button 14 to perform a process in accordance with the input on the operation button 14.

The lower LCD 12 and the upper LCD 22 are connected to the information processing section 31. The lower LCD 12 and the upper LCD 22 each display an image in accordance with an instruction from (the GPU 312 of) the information processing section 31. In the present embodiment, the information processing section 31 causes the upper LCD 22 to display a stereoscopic image (stereoscopically visible image).

Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye, which are stored in the VRAM 313 of the information processing section 31, are outputted to the upper LCD 22. More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the image for the right eye is viewed by the user's right eye, and the image for the left eye is viewed by the user's left eye. Thus, the stereoscopically visible image is displayed on the screen of the upper LCD 22.

The outer imaging section 23 and the inner imaging section 24 are connected to the information processing section 31. The outer imaging section 23 and the inner imaging section 24 each take an image in accordance with an instruction from the information processing section 31, and output data of the taken image to the information processing section 31.

The 3D adjustment switch 25 is connected to the information processing section 31. The 3D adjustment switch 25 transmits, to the information processing section 31, an electrical signal in accordance with the position of the slider 25a. The position of the slider 25a can be detected with the information processing section 31 on the basis of the electrical signal transmitted from the 3D adjustment switch 25. In other words, the 3D adjustment switch 25 is a switch for detecting, as an analog input, an operation input of the user on the slider 25a.

The 3D indicator 26 is connected to the information processing section 31. The information processing section 31 controls whether or not the 3D indicator 26 is to be lit up. For example, the information processing section 31 lights up the 3D indicator 26 when the upper LCD 22 is in the stereoscopic display mode. This is the description regarding the internal configuration of the game apparatus 10.

An operation in the game apparatus 10 according to the present embodiment will be described in more detail. The upper LCD 22 according to the present embodiment is a display device which can switch a display mode between a planar display mode and a stereoscopic display mode as described above. In the present embodiment, the display mode of the display device is restricted to the planar display mode in accordance with an operation of the user.

More specifically, in the present embodiment, when a program for setting the game apparatus 10 (hereinafter, referred to as game apparatus setting program) is executed to set restriction of the display mode, the display mode is restricted to the planar display mode. The game apparatus setting program is executed when its execution being selected by using a launcher program, and the launcher program will be described in detail later.

[Game Apparatus Setting Program]

The game apparatus setting program is a program for causing the CPU 311 to execute a process for setting game apparatus information. The game apparatus information is information which is used by the CPU 311 according to need when the CPU 311 executes a program stored in the internal data storage memory 35 or a storage medium such as the external memory 45. Specific examples of the game apparatus information are current time, a user name (the owner of the game apparatus 10), and information for performing network communication using the wireless communication module 36 or the local wireless communication module 37 (e.g., setting information of an IP address). In addition, information regarding setting of the later-described display mode restriction is also the game apparatus information. In the present embodiment, the game apparatus information is stored in the internal data storage memory 35. However, the game apparatus information may be stored in any storage medium as long as it can be read out according to need when the CPU 311 executes a program.

The restriction of the display mode will be described more specifically. When execution of the game apparatus setting program is selected by the user, buttons indicating setting items of the game apparatus information, such as setting of the current time, setting of the user name, and setting of the display mode restriction, are displayed on the lower LCD 12. In addition, a button indicating end of setting of the game apparatus information is also displayed on the lower LCD 12. In this case, when any of the buttons indicating the setting items is touched, the setting item indicated by the touched button becomes a selected state. Then, an image representing the content of the setting item indicated by the button in the selected state is displayed on the upper LCD 22. The image representing the content of the setting item is, for example, an image representing a display object representing a clock in the case where the setting item is setting of the current time. It is noted that the image representing the content of the setting item may be displayed as a stereoscopic image depending on the setting item.

Then, when the button in the selected state is touched again, a process for setting the setting item indicated by the button is started. For example, when the setting item of the display mode restriction is caused to become a selected state by the user and then the button indicating this setting item is touched again, a process for setting the display mode restriction is started. It is noted that when the number of the setting items is large and all the setting items cannot be displayed on the lower LCD 12, a button indicating a desired setting item may be displayed by performing a slide operation.

When the process for setting the display mode restriction is started, an authentication process of determining whether or not the process has been started by a user who is authorized to set the display mode restriction. When the authentication process is started, a password input screen is displayed and an input of a password is received from a user. When the received password matches a predetermined password, it is determined that the authentication process is successfully completed, and a setting screen for display mode restriction is displayed. On the other hand, when the received password does not match the predetermined password, it is determined that the authentication process cannot successfully be completed, the display returns to the display of the setting items of the game apparatus information. When the received password does not match the predetermined password, other passwords may be allowed to be received a predetermined number of times. In addition, the predetermined password may previously be stored as unique numbers in the game apparatus 10 or may previously be stored as one item of the game apparatus information. Further, also in the case where a password is previously set, this setting may be allowed to be performed when a password which matches an already-stored password (e.g., a password stored as initial values, or a password set by the user) is received.

In the setting screen for display mode restriction, at least two buttons, a button indicating “activate display mode restriction” and a button indicating “inactivate display mode restriction”, are displayed on the lower LCD 12. In this case, among the two buttons displayed in the setting screen of the display mode restriction, a button indicating a current setting state may be highlighted such that the current setting state is visually recognized by the user.

Then, when the button indicating “activate display mode restriction” is touched, it is determined that restriction to only the planar display mode is selected. Then, the display mode is restricted so as to be set to only the planar display mode. On the other hand, when the button indicating setting of “inactivate display mode restriction” is touched, it is determined that release of the restriction to only the planar display mode is selected. Then, setting is made such that the display mode is enabled to be switched between the stereoscopic display mode and the planar display mode, and the restriction to only the planar display mode is released. When the button indicating setting of “activate display mode restriction” or the button indicating setting of “inactivate display mode restriction” is touched to complete the setting, the process for setting the display mode restriction is completed, and the display returns to the display of the setting items of the game apparatus information. In this case, the touched button may be highlighted for a predetermined time period and then the display may return to the display of the setting items of the game apparatus information, such that the result of the setting is visually recognized by the user. Then, when the button for ending setting of the game apparatus information is touched by the user while the setting items of the game apparatus information are displayed, the game apparatus setting program is ended.

In the present embodiment, as is obvious from the above description, selection of a setting item or a selection item, reception of an input of a password, or the like is performed when a button displayed on the lower LCD 12 is touched. Specifically, after images of buttons indicating the respective items and numbers are displayed on the lower LCD 12 according to need, touch position data is sequentially obtained from the touch panel control circuit. Then, on the basis of the obtained touch position data, it is determined whether or not a position on the touch panel 13 corresponding to any of the images of the respective buttons has been touched. When it is determined that any of the images of the buttons has been touched, selection of an item corresponding to the touched button, an input of a password, or the like is performed. It is noted that selection and decision may be made on buttons displayed on the lower LCD 12 by operating the operation button 14, to perform selection of an item, input of a password, and the like. Alternatively, both the touch panel 13 and the operation button 14 may be used to perform selection of an item, decision, an input of a password, and the like. Further, instead of the images of the buttons, icons may be displayed on the lower LCD 12.

In the present embodiment, when “activate display mode restriction” is set, the display mode of the upper LCD 22 is restricted to the planar display mode, and only a planar image is displayed no matter what program is executed.

[Application Program and System Program]

Programs according to the present embodiment are roughly classified into an application program and a system program. An application program is a program which causes the CPU 311 to execute a process of generating an image which is to be displayed on at least either one of the upper LCD 22 or the lower LCD 12.

The later-described launcher program and a later-described game program correspond to application programs. In addition, the aforementioned game apparatus setting program also corresponds to an application program. It is noted that an application program corresponds to any program which causes the CPU 311 to execute a process of generating an image which is to be displayed on a display device, such as the upper LCD 22, which can display at least a stereoscopic image, such as a program for taking a picture with the outer imaging section 23 or the inner imaging section 24 and a program for creating a portrait.

Meanwhile, the system program is a program which is continuously executed while the game apparatus 10 is powered on and which is executed by the CPU 311 in parallel even when the CPU 311 executes the aforementioned application program. More specifically, the system program is a program which causes the CPU 311 to execute in parallel a process of controlling the upper LCD 22.

[Launcher Program]

First, the aforementioned launcher program will be described in more detail. The launcher program according to the present embodiment is a program which causes the CPU 311 to execute a process for causing the user to select another application program stored in the internal data storage memory 35 or the external memory 45 and executing the selected application program. The launcher program is automatically executed when the game apparatus 10 is powered on. When the launcher program is executed, a storage medium which is accessible by the CPU 311 in the game apparatus 10, such as the internal data storage memory 35 or the external memory 45, is referred to. The CPU 311 refers to the accessible storage medium and determines predetermined application programs which are selectable by the user. Here, the application programs which are selectable by the user do not include the launcher program. In other words, the launcher program is a kind of an application program, but is a program which is automatically executed when the game apparatus 10 is powered on, and is not an application program of which execution is selectable by the user. However, it is possible to set the game apparatus information such that when the game apparatus 10 is powered on in a state where the external memory 45 is inserted into the game apparatus 10, an application program stored in the external memory 45 is automatically executed without selection with the launcher program.

When the predetermined application programs which are selectable by the user are determined, these application programs are displayed on the upper LCD 22 and the lower LCD 12 in order to cause the user to make selection. Specifically, icons indicating the application programs which are selectable by the user are displayed on the lower LCD 12. In the present embodiment, an icon sequence in which icons indicating the predetermined application programs are aligned laterally at equal intervals is displayed on the lower LCD 12. In this case, the user can slide a touch position on the touch panel 13 so as to laterally slide the icon sequence displayed on the lower LCD 12, to laterally scroll the icon sequence. Then, an application program indicated by an icon displayed substantially at the lateral center of the lower LCD 12, among the icons included in the icon sequence which is slid by the user, becomes a selected state.

As described above, while the icon sequence is displayed on the lower LCD 12, content information indicating a content of the application program in the selected state is displayed on the upper LCD 22. The content information is specifically data indicating an image, a moving image, a display object, sound, and the like which indicate contents provided by the application program, and is information included in each application program. For example, when a selected application program is a program for a racing game, it is considered that data of display objects representing cars appearing in the game is included as content information. When such an application program including content information is in a selected state, the display objects of the cars are displayed on the upper LCD 22. In addition, among the application programs, some application programs include, as content information, data indicating stereoscopically visible images.

Therefore, in response to sliding of the icon sequence displayed on the lower LCD 12 by the user, the icon positioned substantially at the lateral center is interchanged to switch the application program in the selected state. Then, in accordance with the switching of the application program in the selected state, the content information displayed on the upper LCD 22 is also switched to content information of an application program after the switching. Further, when the icon of the application program in the selected state is touched, the program is set as a program to be executed. When the application program to be executed is set, the launcher program causes the CPU 311 to execute a process of confirming setting of the display mode restriction, prior to execution of the set program.

First, the case where it is confirmed that the display mode is restricted to only the planar display mode will be described. In the case where it is confirmed that the display mode is restricted to only the planar display mode, it is determined whether or not an application program to be executed is a program which includes a process for causing the upper LCD 22 to display a stereoscopically visible image (hereinafter, referred to as stereoscopic image). When it is determined that the application program to be executed is a program which includes a process for causing the upper LCD 22 to display a stereoscopic image, a screen for confirming whether or not to release the restriction to only the planar display mode is displayed on the lower LCD 12.

In the confirmation screen for restriction release, first, at least two buttons, a button indicating the planar display mode and a button indicating the stereoscopic display mode, are displayed on the lower LCD 12. Then, when the button indicating the planar display mode is touched, it is determined that it is selected not to release the restriction to only the planar display mode. Then, the application program is executed without releasing the restriction to only the planar display mode.

On the other hand, when the button indicating the stereoscopic display mode is touched, it is determined that it is selected to release the restriction to the planar display mode. When it is determined that it is selected to release the restriction to the planar display mode, an authentication process is started similarly to that when the process for setting the display mode restriction is started. The authentication process started in this case is a process for authenticating an appropriate user who is accepted as a target for a display of a stereoscopic image. However, the specific content of the process is the same as that of the aforementioned authentication process. In other words, a password input screen is displayed and reception of a password is started. Then, when a received password matches a predetermined password, the restriction to the planar display mode is released. Then, when a stereoscopic image is generated by execution of the application program, the stereoscopic image is displayed on the upper LCD 22 as it is. It is noted that the release of the restriction to the planar display mode at this time is temporary restriction release which is to be cancelled when the executed application program is ended. On the other hand, when the received password does not match the predetermined password, execution of the application program is started without releasing the restriction to the planar display mode. When the received password does not match the predetermined password, other passwords may be allowed to be received a predetermined number of times. Alternatively, when the received password does not match the predetermined password, the setting of executing the application program may be cancelled and the processing may return to the process of the launcher program.

Next, the case where when an application program to be executed is set, it is confirmed that the display mode is not restricted to only the planar display mode, will be described. In the case where the display mode is not restricted to only the planar display mode, the confirmation screen for restriction release is not displayed, and the set application program is executed. In this case, when a stereoscopic image is generated by execution of the application program, the stereoscopic image is displayed on the upper LCD 22 as it is.

In any of: the case where an application program is executed in a state where the display mode is restricted to only the planar display mode; and the case where an application program is executed in a state where the display mode is not restricted to only the planar display mode, when the application program is executed through the launcher program, the launcher program is also executed in parallel. However, while the application program is executed, only a process of waiting for end of the application program is performed as a process by the launcher program. Further, the launcher program is an application program which is automatically executed when the game apparatus 10 is powered on and which is continuously executed in parallel even when another application program is executed.

In the present embodiment, while the launcher program is executed, an operation for sliding the icon sequence, setting of an application program to be executed, reception of an input of a password, and the like are performed when the icons and the buttons displayed on the lower LCD 12, and the like are touched, as is obvious from the above description. Specifically, after an icon sequence composed of icons indicating the respective application programs, images representing buttons indicating numbers, and the like are displayed on the lower LCD 12 according to need, touch position data is sequentially obtained from the touch panel control circuit. Then, on the basis of the obtained touch position data, it is determined whether or not a position on the touch panel 13 corresponding to any of the positions of the displayed images has been touched, and whether or not a sliding operation has been performed in addition to the touching. When it is determined that any of the images has been touched or a sliding operation has been performed thereon, setting of an application program corresponding to the operated button, an input of a password, sliding display of the icon sequence, or the like is performed. It is noted that selection and decision may be made on buttons displayed on the lower LCD 12 by operating the operation button 14, to perform these processes. Alternatively, both the touch panel 13 and the operation button 14 may be used to perform these processes.

[Other Application Programs]

As described above, the game program also corresponds to an application program executed by the CPU 311. The game program is a program which causes the CPU 311 to execute a process of generating an image which is to be displayed on at least either one of the lower LCD 12 or the upper LCD 22. It is noted that the game program is an application program different from the aforementioned game apparatus setting program and launcher program. In addition, the game program is an application program which is executed in parallel with the aforementioned system program and launcher program. Moreover, the game program is a typical program which causes the CPU 311 to execute an optional game process, and thus the detailed description thereof is omitted.

[System Program]

Next, the system program will be described. The system program is a program which causes the CPU 311 to execute a process of controlling the upper LCD 22 in parallel with a process by a program such as an application program and the launcher program.

When the system program is executed, information regarding setting of the display mode restriction, which is stored as game apparatus information in the internal data storage memory 35, is referred to. As a result of referring to the setting of the display mode restriction, when the display mode is restricted to the planar display mode, an image generated by executing an application program in parallel is restricted to a planar image and displayed. On the other hand, as a result of referring to the setting of the display mode restriction, when the display mode is not restricted to the planar display mode, an image generated by executing an application program in parallel is displayed as it is, regardless of whether the generated image is a stereoscopic image or a planar image.

First, a process by the system program in the case where the display mode is not restricted to the planar display mode will be described. As described above, various programs such as the game apparatus setting program, the launcher program, and the game program correspond to application programs. These application programs include various processes corresponding to their purposes, as processes to be executed by the CPU 311. However, among the processes included in these application programs, processes for displaying stereoscopic images on the upper LCD 22 can be roughly classified into two processes. Specifically, the two processes are a process of generating a stereoscopic image in the game apparatus 10 and a process of reproducing a previously generated stereoscopic image in the game apparatus 10. Further, one example of the process of generating a stereoscopic image in the game apparatus 10 is a process of generating, as a stereoscopic image, two images having a disparity. In the present embodiment, as the process of generating two images having a disparity, either one of a process of generating two images by using a virtual camera or a process of generating two images by causing the outer imaging section 23 to serve as a stereo camera is executed. However, in another embodiment, any process of generating two images having a disparity may be executed. The process of generating two images having a disparity also includes a conventionally-known process of processing a single image having no disparity to convert the single image into two images having a disparity, which are stereoscopically viewable in a pseudo manner.

First, a process of generating a stereoscopic image by using a virtual camera will be described. When a stereoscopic image is generated by using the virtual camera, two images having a disparity are generated as the stereoscopic image. In order to generate the two image having a disparity, a process of taking images of a virtual object with two virtual cameras located in a virtual space is performed. The two virtual cameras located in the virtual space are located at an interval (hereinafter, referred to as a virtual camera interval) corresponding to a disparity which occurs when an object is viewed with both eyes of the user. In addition, the two virtual cameras located in the virtual space are located in the virtual space as left and right virtual cameras corresponding to the left and right eyes, respectively, of the user.

When the two virtual cameras are located in the virtual space, the positions and orientations of the virtual cameras in the virtual space are set. It is noted that in the present embodiment, the position and orientation of a reference virtual camera are set before the positions and orientations of the left and right virtual cameras are set. Giving a description regarding the reference virtual camera, in the present embodiment, an image for a left eye and an image for a right eye are generated such that an image obtained by taking a virtual space, a virtual object, and the like with the single reference virtual camera located in the virtual space at a predetermined position and in a predetermined orientation will be visually recognized as a stereoscopic image. In other words, the reference virtual camera is a virtual camera which is located at a reference position and in a reference orientation for locating the left and right virtual cameras in the virtual space in order to generate an image for a left eye and an image for a right eye.

An application program causes the CPU 311 to execute a process of setting the position and orientation of the reference virtual camera in the virtual space on the basis of a predetermined algorism and then generating, as a reference virtual camera matrix, a matrix (array) composed of values indicating the set specific position and orientation. The reference virtual camera matrix suffices to be information for setting the reference virtual camera in the virtual space, and may include the information regarding the position and orientation of the reference virtual camera as well as any other information such as information for setting the depth of a stereoscopic image which is visually recognized.

The system program causes the CPU 311 to execute a process of setting the positions and orientations of the left and right virtual cameras in the virtual space. When the display mode is not restricted to the planar display mode, the slide position of the slider 25a of the 3D adjustment switch 25 is used in addition to the reference virtual camera matrix, in order to set the position and the orientation of each virtual camera. The system program causes the CPU 311 to execute a process of setting the positions and orientations of the left and right virtual cameras in accordance with the slide position of the slider 25a to switch between the planar display mode and the stereoscopic display mode or adjust the stereoscopic degree of a stereoscopic image.

More specifically, when the position and orientation of each virtual camera are set, the slide position of the slider 25a is initially detected. Then, the positions and orientations of the left and right virtual cameras are set such that a stereoscopic image having a stereoscopic degree corresponding to the slide position of the slider 25a will be generated. Here, the stereoscopic degree is the degree of a stereoscopic effect provided when the user views a stereoscopic image. The stereoscopic image may include a three-dimensional object visually recognized by the user as being stereoscopic as well as a planar object visually recognized as being planar, or a planar image.

In the present embodiment, a stereoscopic degree of zero is set when the slider 25a is located at the above third position, and a stereoscopic degree is set to a predetermined maximum value when the slider 25a is located at the above second position. In addition, when the slider 25a is located at the above first position, a stereoscopic degree is set to a predetermined initial value. Thus, when the slider 25a is located at the third position, a stereoscopic degree of zero is set and hence the display mode is switched to the planar display mode. In addition, when the slider 25a is located at the first position, a stereoscopic degree is set to the predetermined initial value and hence the display mode is switched to the stereoscopic display mode. The stereoscopic degree is set so as to increase from the predetermined initial value to the predetermined maximum value as the slide distance of the slider 25a increases from the first position toward the second position. It is noted that when the slider 25a is located at the third position, no stereoscopic degree may be set, whereby the display mode is switched to the planar display mode.

In the present embodiment, virtual camera intervals are set in accordance with the stereoscopic degree which is set as described above. The virtual camera intervals are intervals between the position of the reference virtual camera and the positions of the left and right virtual cameras located in the virtual space. In other words, the left virtual camera is located in the virtual space such that the interval between the position of the reference virtual camera and the left virtual camera is its virtual camera interval. Meanwhile, the right virtual camera is located such that the interval between the position of the reference virtual camera and the right virtual camera is its virtual camera interval. In addition, the left and right virtual cameras are located at positions translated from the position of the reference virtual camera in directions opposite to each other. Thus, the orientations of the left and right virtual cameras are set to orientations which are orientations of the reference virtual camera which has been translated in the above directions.

When a stereoscopic degree of zero is set, the virtual camera intervals are set to zero. Thus, when a stereoscopic degree of zero is set, the positions of the left and right virtual cameras are set to the same position as that of the reference virtual camera. When the positions of the left and right virtual cameras are the same, the orientations of these virtual cameras are also the same, namely, are the same as the orientation of the reference virtual camera, and thus an image for a left eye and an image for a right eye which are the same are taken. When the same images are displayed on the upper LCD 22, the same images are viewed with the left and right eyes of the user through the parallax barrier as described above. In other words, the image for a left eye and the image for a right eye which are viewed with both eyes of the user become planar images which do not have a disparity and are not stereoscopically viewable. Thus, when the slider 25a is located at the third position, the display mode is switched to the planar display mode in which a planar image is displayed.

When a stereoscopic degree is set so as to range from the predetermined initial value to the predetermined maximum value, the virtual camera intervals are set so as to increase from a predetermined initial value to a predetermined maximum value as the set stereoscopic degree increases. Thus, the positions of the left and right virtual cameras are set such that the intervals from the position of the reference virtual camera laterally increase as the set stereoscopic degree increases. Accordingly, an amount of deviation between an image for a left eye, which is taken with the left virtual camera, and an image for a right eye, which is taken with the right virtual camera, is adjusted in accordance with the set stereoscopic degree. Due to such adjustment of an amount of deviation between an image for a left eye and an image for a right eye, the image for a left eye and the image for a right eye can be generated as a stereoscopic image having a stereoscopic degree which is set in accordance with the slide position of the slider 25a.

After the process of setting the positions and orientations of the left and right virtual cameras is performed, the system program causes the CPU 311 to execute a process of generating an application virtual camera matrix composed of variables indicating the position and orientation of each of these virtual cameras. The application virtual camera matrix suffices to be information for setting each of the left and right virtual cameras in the virtual space, and may include information indicating optional settings, in addition to the position and orientation of each of these virtual cameras.

While the system program causes the CPU 311 to execute the process of setting the positions and orientations of the left and right virtual cameras, the application program causes the CPU 311 to execute a process of taking images of the virtual space with these virtual cameras. Specifically, the application program causes the CPU 311 to execute a process of locating the left and right virtual cameras at the positions and in the orientations which are indicated by the application virtual camera matrixes. Then, the application program causes the CPU 311 to execute a process of taking images of the virtual space and a virtual object present in the virtual space with the located virtual cameras, to generate an image for a left eye and an image for a right eye as a stereoscopic image. The image for a left eye and the image for a right eye which are generated as a stereoscopic image by execution of the application program are rendered by the VRAM 313.

This is the description regarding the process of generating a stereoscopic image by using the virtual cameras. As described above, in the present embodiment, not the application program, the system program causes the CPU 311 to execute the process of setting the positions and orientation of the left and right virtual cameras on the basis of the stereoscopic degree which is set by the CPU 311 in accordance with the slide position of the slider 25a. Thus, different application programs including processes of generating stereoscopic images having different stereoscopic effects even when the slide position of the slider 25a is the same are prevented from being executed, and stereoscopic effects can be made uniform by the system program.

Next, the process of causing the outer imaging section 23 to serve as a stereo camera and generating a stereoscopic image will be described. As described above, the outer imaging section (left) 23a and the outer imaging section (right) 23b can be caused to serve as stereo cameras. More specifically, the interval between the outer imaging section (left) 23a and the outer imaging section (right) 23b is set to an interval equivalent to the interval between both eyes of a person as described above, and is an interval corresponding to a disparity occurring when a person (user) views an object. Thus, an image for a left eye, which is to be viewed with the left eye of the user, and an image for a right eye, which is to be viewed with the right eye of the user, can be taken as a stereoscopic image. An example of an application program which causes the outer imaging section (left) 23a and the outer imaging section (right) 23b to serve as stereo cameras is a program which edits a taken stereoscopic image as a picture or stores the image. A stereoscopic image is generated by execution of such an application program, for example, when the L button 14G or the R button 14H assigned a function as a shutter button by the program is pressed in a situation where a previously prepared picture is taken. Then, when the stereoscopic image generated thus is displayed on the upper LCD 22, the application program causes the CPU 311 to execute a process of causing the VRAM 313 to render an image for a left eye and an image for a right eye which constitute the stereoscopic image.

When a stereoscopic image generated by using the outer imaging section 23 is displayed, the system program may cause the CPU 311 to execute a process for switching the display mode by using the 3D adjustment switch 25. In such a case, the system program may cause the CPU 311 to selectively execute a process of displaying an image for a left eye and an image for a right eye, which are rendered by the VRAM 313, at predetermined display positions on the upper LCD 22, or a process of displaying only one of these images at the center of the upper LCD 22. Specifically, for example, when the slider 25a is located at the third position, the system program causes the CPU 311 to execute a process of switching the display mode to the planar display mode, outputting either one of the image for a left eye and the image for a right eye, which constitute the previously generated stereoscopic image, as a planar image from the VRAM 313, and displaying the image at the center of the upper LCD 22. When the slider 25a is located at any position between the first position and the second position, the system program causes the CPU 311 to execute a process of outputting both the image for a left eye and the image for a right eye, which constitute the previously generated stereoscopic image, from the VRAM 313 and displaying the images at predetermined positions on the upper LCD 22, for switching the display mode to the stereoscopic display mode.

The stereoscopic image generated by using the outer imaging section 23 is previously generated as a stereoscopic image having a disparity corresponding to the interval between the outer imaging section (left) 23a and the outer imaging section (right) 23b. Thus, when the slider 25a is located at any position between the first position and the second position, the stereoscopic degree cannot be set in accordance with the position of the slider 25a.

Next, the case where a previously-generated stereoscopic image is reproduced in the game apparatus 10 will be described. In the present embodiment, a still image or moving image which is a previously-generated stereoscopic image can be stored in an optional storage medium such as the internal data storage memory 35 or the external memory 45. Then, a program which causes the CPU 311 to execute a process of displaying and reproducing the still image or moving image, which is the stereoscopic image stored in each of these storage media, on the upper LCD 22 also corresponds to an application program. When such a previously-generated stereoscopic image is reproduced, the system program causes the CPU 311 to execute a program of reading an image for a left eye and an image for a right eye which are previously stored in the storage medium, as a stereoscopic image according to need, and causing the VRAM 313 to render these images each time these images are read.

When the previously-generated stereoscopic image is reproduced, the system program may also cause the CPU 311 to execute a process for switching the display mode by using the 3D adjustment switch 25. In such a case, the system program causes the CPU 311 to selectively execute a process of displaying an image for a left eye and an image for a right eye, which are rendered by the VRAM 313, at predetermined display positions on the upper LCD 22, or a process of displaying only either one of these images at the center of the upper LCD 22. Specifically, for example, when the slider 25a is located at the third position, the system program causes the CPU 311 to execute a process of outputting either one of the image for a left eye and the image for a right eye, which constitute the previously-generated stereoscopic image, from the VRAM 313 and displaying the image at the center of the upper LCD 22, for switching the display mode to the planar display mode. When the slider 25a is located at any position between the first position and the second position, the system program causes the CPU 311 to execute a process of outputting both the image for a left eye and the image for a right eye, which constitute the previously-generated stereoscopic image, from the VRAM 313 and displaying these images at predetermined positions on the upper LCD 22, for switching the display mode to the stereoscopic display mode.

The previously-generated stereoscopic image is generated as a stereoscopic image having a predetermined disparity. Thus, when the slider 25a is located at any position between the first position and the second position, the stereoscopic degree cannot be set in accordance with the position of the slider 25a.

This is the description regarding an example of the process for displaying a stereoscopic image on the upper LCD 22. The process for displaying a stereoscopic image on the upper LCD 22 includes various types of processes as described above. An application program is a program which includes at least one of the processes described above, as a process for displaying a stereoscopic image on the upper LCD 22. For example, the aforementioned launcher program may include a stereoscopic image as content information of an application program, and the application program includes at least a process of displaying the stereoscopic image on the upper LCD 22. In addition, for example, the aforementioned game apparatus setting program may display a stereoscopic image as an image indicating the content of a setting item in a selected state, and includes at least a process for displaying the stereoscopic image.

Meanwhile, as is obvious from the above description, the system program causes the CPU 311 to execute a process of restricting a stereoscopic image which is to be displayed on the upper LCD 22, to a planar image when the display mode is restricted to the planar display mode, even though the stereoscopic image is generated by any process. Hereinafter, the case where the system program causes the CPU 311 to execute a process of displaying an image on the upper LCD 22 when the display mode is restricted to the planar display mode, will be described.

First, a process of restricting a display of a stereoscopic image generated by suing the virtual cameras will be described. When a stereoscopic image is generated by using the virtual cameras, the application program causes the CPU 311 to execute a process of generating a reference virtual camera matrix indicating the position and orientation of the reference virtual camera, as described above. Then, the system program causes the CPU 311 to execute a process of generating an application virtual camera matrix indicating the position and orientation of each of the left and right virtual cameras, in accordance with the generated reference virtual camera matrix. When the display mode is restricted to the planar display mode, the system program causes the CPU 311 to execute a process of generating restricted application virtual camera matrixes. Specifically, the system program causes the CPU 311 to execute a process of generating a restricted application virtual camera matrix which is composed of numerical values indicating, as the position of each of the left and right virtual cameras, a virtual camera interval of zero and a position which is the same as the position of the reference virtual camera. The application virtual camera matrixes generated at this time are generated regardless of the slide position of the slider 25a of the 3D adjustment switch 25. For example, the system program may cause the CPU 311 to execute a process of generating application virtual camera matrixes on the basis of only the reference virtual camera matrix without detecting the slide position. Alternatively, the system program may cause the CPU 311 to execute a process of generating application virtual camera matrixes such that a stereoscopic degree which is set on the basis of the detected slide position is not reflected therein and only the numerical values indicated by the reference virtual camera matrix are reflected therein.

When the application virtual camera matrixes indicating the identical position as the positions of the left and right virtual cameras are generated, the application program causes the CPU 311 to execute a process of generating an image for a left eye and an image for a right eye which are the same. The image for a left eye and the image for a right eye which are the same are displayed on the upper LCD 22 as planar images as described above. As described above, when a stereoscopic image generated by using the virtual cameras is restricted to a planar image, the system program causes the CPU 311 to execute the process of generating the restricted application virtual camera matrixes.

Next, a process of displaying a stereoscopic image generated when the outer imaging section 23 is caused to serve as a stereo camera, such that the image is restricted to a planar image will be described. A stereoscopic image taken with the outer imaging section 23 is rendered by the VRAM 313 and outputted as described above. Thus, when the stereoscopic image taken with the outer imaging section 23 is restricted to the planar image, the system program causes the CPU 311 to execute a process of outputting only one of the images rendered by the VRAM 313 such that the image is displayed at the center of the upper LCD 22. In this case, the system program also causes the CPU 311 to execute a process of instructing the LCD controller to turn off the parallax barrier of the upper LCD 22. Due to this, only either one of the images rendered by the VRAM 313 is outputted to the upper LCD 22, and viewed with both eyes of the user, not through the parallax barrier. In other words, the image viewed with both eyes of the user becomes a planar image which does not have a disparity and is not stereoscopically viewable. When the stereoscopic image generated by using the outer imaging section 23 is restricted to a planar image, the system program causes the CPU 311 to execute a process of outputting only either one of the images rendered by the VRAM 313 as described above.

Next, a process of, when a previously-generated stereoscopic image is reproduced, displaying the stereoscopic image so as to restrict the stereoscopic image to a planar image will be described. The process of, when a previously-generated stereoscopic image is reproduced, restricting the stereoscopic image to a planar image has the same method as that when a stereoscopic image generated by using the outer imaging section 23 is restricted to a planar image. In other words, the system program causes the CPU 311 to execute a process of restrictively outputting only either one of images rendered by the VRAM 313. In this case, the system program may also cause the CPU 311 to execute a process of instructing the LCD controller to turn off the parallax barrier of the upper LCD 22 as described above.

As is obvious from the above description, in the present embodiment, stereoscopic images generated by various methods are restricted to planar images by execution of the system program. Thus, when setting of the display mode restriction is restriction to only the planar display mode, a stereoscopic image generated by any method as a result of execution of an application program can be displayed so as to be restricted to a planar image. In other words, regardless of an application program to be executed, a stereoscopic image can be displayed so as to be restricted to a planar image by execution of the system program.

When a stereoscopic image generated by using the virtual cameras is restricted to a planar image, the CPU 311 may be caused to execute a process of displaying only either one of an image for a left eye and an image for a right eye, which are rendered by the VRAM 313, at the center of the upper LCD 22. More specifically, when a stereoscopic image is generated by using the virtual cameras, the system program causes the CPU 311 to execute the process of generating application virtual camera matrixes indicating the identical position, as described above. However, an application program can be configured to generate an image for a left eye and an image for a right eye as a stereoscopic image without using the application virtual camera matrixes. In other words, the application program can also cause the CPU 311 to execute a process of setting the positions and orientations of the left and right virtual cameras in the virtual space and generating an image for a left eye and an image for a right eye. Then, when a stereoscopic image is generated by execution of such an application program, even if application virtual camera matrixes indicating the identical position are generated as described above, the application virtual camera matrixes are neglected. Thus, an image for a left eye and an image for a right eye are generated as a stereoscopic image which has a disparity and is stereoscopically viewable, and are rendered by the VRAM 313. In such a case as well, only either one of the image for a left eye and the image for a right eye which are rendered by the VRAM 313 is displayed at the center of the display screen of the upper LCD 22, whereby the stereoscopic image can be displayed so as to be restricted to a planar image. In this case, the system program may also cause the CPU 311 to execute a process of instructing the LCD controller to turn off the parallax barrier of the upper LCD 22 as described above.

However, the application program may cause the CPU 311 to execute a process of setting the positions and orientations of the left and right virtual cameras in the virtual space and generating an image for a left eye and an image for a right eye, for displaying a stereoscopic image. In this case, the application program may cause the CPU 311 to execute a process of detecting the slide position of the slider 25a.

This is the description regarding an example of the process of displaying a stereoscopic image so as to restrict the stereoscopic image to a planar image in the present embodiment. In the present embodiment, by execution of the system program, an image to be displayed on the upper LCD 22 is restricted in accordance with the setting of the display mode restriction as described above.

When only either one of an image for a left eye and an image for a right eye which are rendered by the VRAM 313 is outputted for restriction to a planar image, either one of the images is copied as the other image, and the image for a left eye and the image for a right eye which are the same may be displayed on the upper LCD 22. The image for a left eye and the image for a right eye which are the same are displayed as planar images on the upper LCD 22 as described above.

When only either one of an image for a left eye and an image for a right eye which are rendered by the VRAM 313 is outputted for restriction to a planar image, the parallax barrier may be turned off as described above and the brightness of a backlight which is not shown may be decreased. More specifically, the parallax barrier is located so as to cover the display surface of the upper LCD 22, and when turned on, the parallax barrier screens the display surface such that each of the image for a left eye of the image for a right eye is not viewed with either one of the eyes. Thus, when the parallax barrier is turned on, it becomes a state where light emitted from the backlight of the upper LCD 22 is blocked. On the other hand, when the parallax barrier is turned off, the light emitted from the backlight of the upper LCD 22 is not blocked, and thus the substantially same brightness as that when the parallax barrier is turned on can be maintained even when the amount of the light is decreased. By decreasing the brightness of the backlight when the parallax barrier is turned off as described above, the power consumption of the game apparatus 10 can be reduced to achieve power saving.

Other than the processes described above, the system program causes the CPU 311 to execute a process of controlling lighting of the 3D indicator 26 in accordance with the setting of the display mode restriction or a rendered state of an image.

More specifically, when the display mode restriction is not set to restriction to only the planar display mode, the system program causes the CPU 311 to execute a process of lighting up the 3D indicator 26 in accordance with an image rendered by the VRAM 313. For example, when both an image for a left eye and an image for a right eye are rendered as a stereoscopic image by the VRAM 313, the system program causes the CPU 311 to execute a process of lighting up the 3D indicator 26 as it is in a state where it is possible to display a stereoscopic image. Meanwhile, when only a single image is rendered by the VRAM 313 as an image to be outputted to the upper LCD 22, for example, when an application program causes the CPU 311 to execute a process of generating only either one of an image for a left eye or an image for a right eye, or a planar image (a single image), the system program causes the CPU 311 to execute a process of turning off the 3D indicator 26 as it is in a state where a stereoscopic image cannot be displayed.

Meanwhile, when the display mode is restricted to only the planar display mode, the system program causes the CPU 311 to execute a process of turning off the 3D indicator 26 regardless of an image rendered by the VRAM 313. Due to this, when the display mode is restricted to the planar display mode, even if a stereoscopic image is rendered by the VRAM 313, switching of a display by the upper LCD 22 to a display of a stereoscopic image can be prevented from being needlessly performed with the 3D adjustment switch 25.

[Data Stored in Main Memory]

Next, various programs stored in the main memory 32 and various data stored in the main memory 32 in accordance with the CPU 311 executing the various programs in the present embodiment will be described.

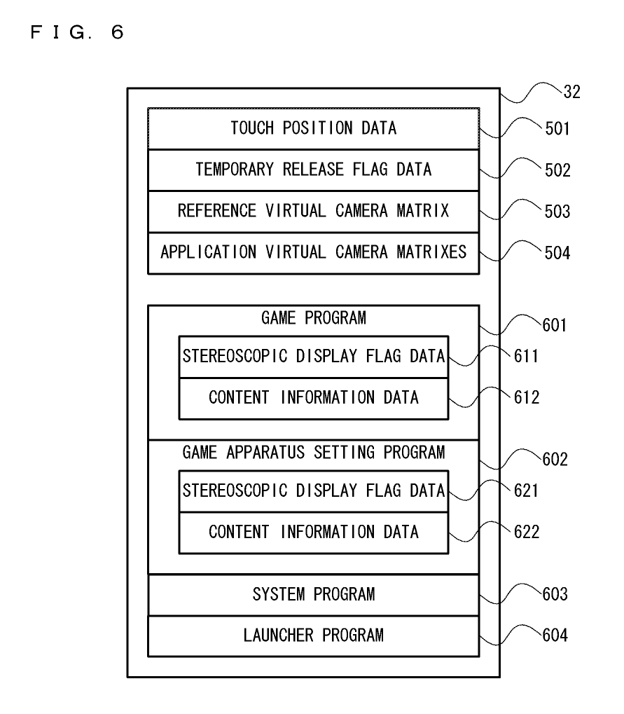

FIG. 6 is a diagram illustrating an example of the various data and the various programs stored in the main memory 32 according to the present embodiment. Stored in the main memory 32 are touch position data 501, temporary release flag data 502, a reference virtual camera matrix 503, application virtual camera matrixes 504, a game program 601, a game apparatus setting program 602, a system program 603, and a launcher program 604.

The touch position data 501 is data indicating, as a touch position, a coordinate of a position, on an input surface of the touch panel 13, on which an input is made. The touch position data 501 is obtained by the CPU 311 from the touch panel control circuit every predetermined time, and stored in the main memory 32.

The temporary release flag data 502 is data indicating whether or not restriction to the planar display mode is temporarily released. Specifically, the temporary release flag data 502 is flag data which represents ON when the restriction to the planar display mode is temporarily released and which represents OFF when the restriction to the planar display mode is not temporarily released (it is restricted to only the planar display mode).

The reference virtual camera matrix 503 is a matrix which is generated by an application program being executed by the CPU 311 and is composed of numerical values indicating at least the position and orientation of the reference virtual camera. In another embodiment, instead of the reference virtual camera matrix 503, information for setting at least the position and orientation of the reference virtual camera may be used as setting information.

The application virtual camera matrixes 504 are matrixes which are generated by the system program being executed by the CPU 311 and are composed of numerical values indicating the positions and orientations of the left and right virtual cameras, respectively. In another embodiment, instead of the application virtual camera matrixes 504, information for setting at least the positions and orientations of the left and right virtual cameras may be used as setting information.

The game program 601 is a program for causing the CPU 311 to execute an optional game process. As shown in FIG. 6, the game program 601 includes stereoscopic display flag data 611 and content information data 612. In addition, the game program 601 also includes a program code which is not shown. The stereoscopic display flag data 611 is data indicates whether or not the game program 601 is a program which causes the CPU 311 to execute processes including a process of generating a stereoscopic image. The stereoscopic display flag data 611 represents ON when a process of generating a stereoscopic image is included, and represents OFF when a process of generating a stereoscopic image is not included. When the game program 601 includes a process of generating a stereoscopic image, the stereoscopic display flag data 611 included in the game program 601 is set to ON. On the other hand, when the game program 601 does not include a process of generating a stereoscopic image, the stereoscopic display flag data 611 included in the game program 601 is set to OFF. The content information data 612 is data indicating, as content information, information indicating contents of a game provided by the game program 601, such as images, moving images, display objects, and sounds. The stereoscopic display flag data 611 and the content information data 612, which are included in the game program 601, are loaded from the storage medium (the internal data storage memory 35 and the external memory 45) of the game program 601 into the main memory 32 by the launcher program being executed by the CPU 311. In addition, the program code included in the game program 601 is loaded from the storage medium of the game program 601 into the main memory 32 when the game program 601 is executed.

The game apparatus setting program 602 is a program which causes the CPU 311 to execute a process for setting the game apparatus information. As shown in FIG. 6, the game apparatus setting program 602 includes stereoscopic display flag data 621 and content information data 622. In addition, the game apparatus setting program 602 also includes a program code which is not shown. The stereoscopic display flag data 621 is data indicating whether or not the game apparatus setting program 602 is a program which causes the CPU 311 to execute processes including a process of generating a stereoscopic image. The stereoscopic display flag data 621 represents ON when a process of generating a stereoscopic image is included, and represents OFF when a process of generating a stereoscopic image is not included. In the present embodiment, the game apparatus setting program 602 includes a process of displaying information indicating a selected setting item, as a stereoscopic image on the upper LCD 22. Thus, in the present embodiment, the stereoscopic display flag data 621 is data representing ON. However, in another embodiment, the game apparatus setting program 602 may include a process of generating a stereoscopic image. The stereoscopic display flag data 621 and the content information data 622, which are included in the game apparatus setting program 602, are loaded from the storage medium (the internal data storage memory 35 in the present embodiment) of the game apparatus setting program 602 into the main memory 32 by the launcher program being executed by the CPU 311.

The system program 603 is loaded from the internal data storage memory 35 into the main memory 32 when the game apparatus 10 is powered on and a boot program stored in a ROM (Read Only Memory) which is not shown is executed by the CPU 311.

The launcher program 604 is a program which causes the CPU 311 to execute a process of causing the user to select another application program stored in the internal data storage memory 35 or the external memory 45 and executing the selected application program, as described above. The launcher program 604 is automatically loaded from the internal data storage memory 35 into the main memory 32 when the system program 603 is loaded. This is the description regarding the various data and the various data stored in the main memory 32 in the present embodiment.

[Data Stored in Internal Data Storage Memory]

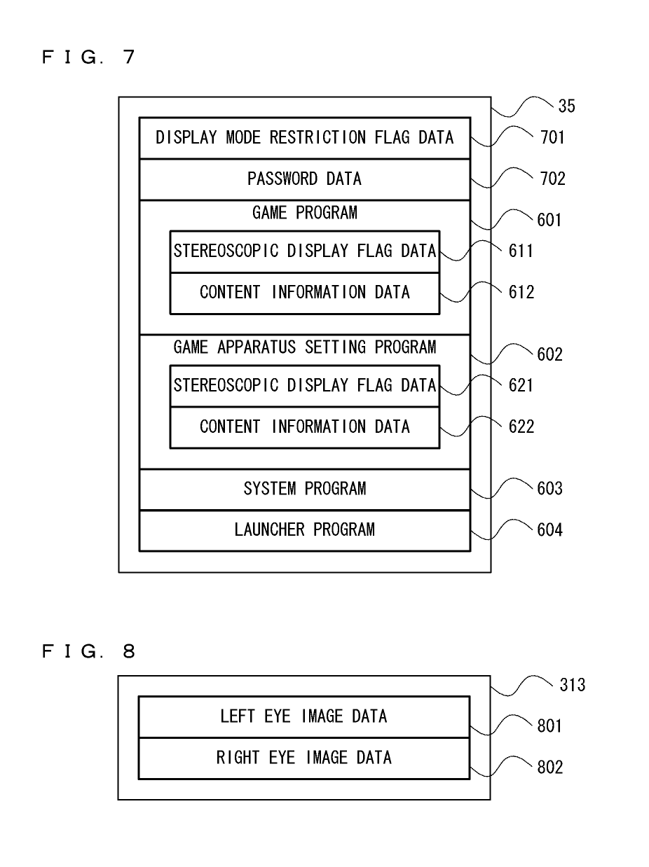

Next, various data and various programs stored in the internal data storage memory 35 will be described. FIG. 7 is a diagram illustrating the various data and the various programs stored in the internal data storage memory 35 in the present embodiment. As shown in FIG. 7, in the internal data storage memory 35, display mode restriction flag data 701, password data 702, the game program 601, the game apparatus setting program 602, the system program 603, and the launcher program 604 are stored.

The display mode restriction flag data 701 is data indicating whether or not a display of an image on the upper LCD 22 is restricted to only the planar display mode. Specifically, the display mode restriction flag data 701 represents ON when it is restricted to only the planar display mode, and represents OFF when it is possible to display an image in the planar display mode or the stereoscopic display mode (it is not restricted to only the planar display mode).

The password data 702 is data indicating a predetermined password used for setting the display mode restriction and for temporarily releasing the display mode restriction.

The game program 601, the game apparatus setting program 602, the system program 603, and the launcher program 604 are previously stored in the internal data storage memory 35 as shown in FIG. 7, and are loaded into the main memory 32 according to need as described above. It is noted that the game program 601 may be stored in the external memory 45, not in the internal data storage memory 35. This is the description regarding the various data and the various programs stored in the internal data storage memory 35.

[Data Stored in VRAM]

Next, various data stored in the VRAM 313 will be described. FIG. 8 is a diagram illustrating the various data stored in the VRAM 313 in the present embodiment. As shown in FIG. 8, in the VRAM 313, left eye image data 801 and right eye image data 802 are stored. The left eye image data 801 and the right eye image data 802 are generated by various programs being executed by the CPU 311, as data indicating an image for a left eye and an image for a right eye, respectively, which constitute a stereoscopic image which is stereoscopically viewable, and are stored in the VRAM 313. These data is the various data stored in the VRAM 313. In the present embodiment, image data generated by an application program being executed by the CPU 311 is rendered directly by the VRAM 313 and stored therein as described above. However, in another embodiment, image data generated by an application program being executed by the CPU 311 may be stored in the main memory 32, and the image indicated by the data stored in the main memory 32 may be outputted to and displayed on the upper LCD 22 or the lower LCD 12.

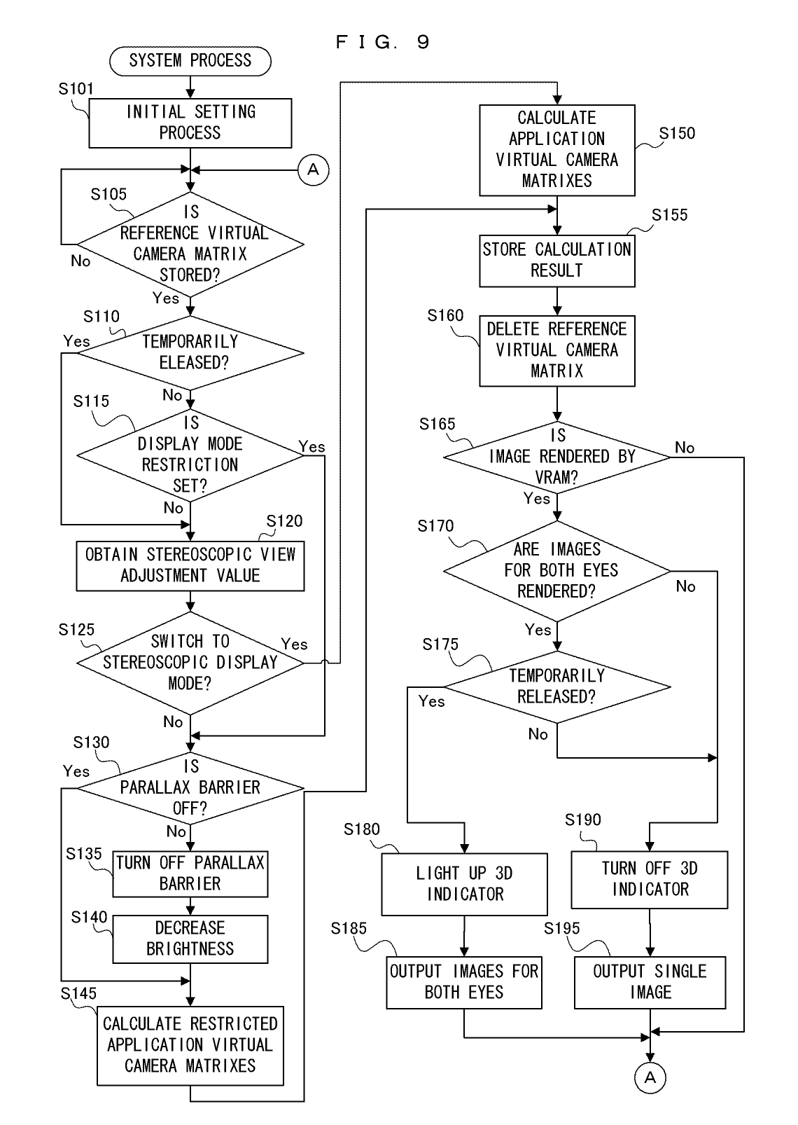

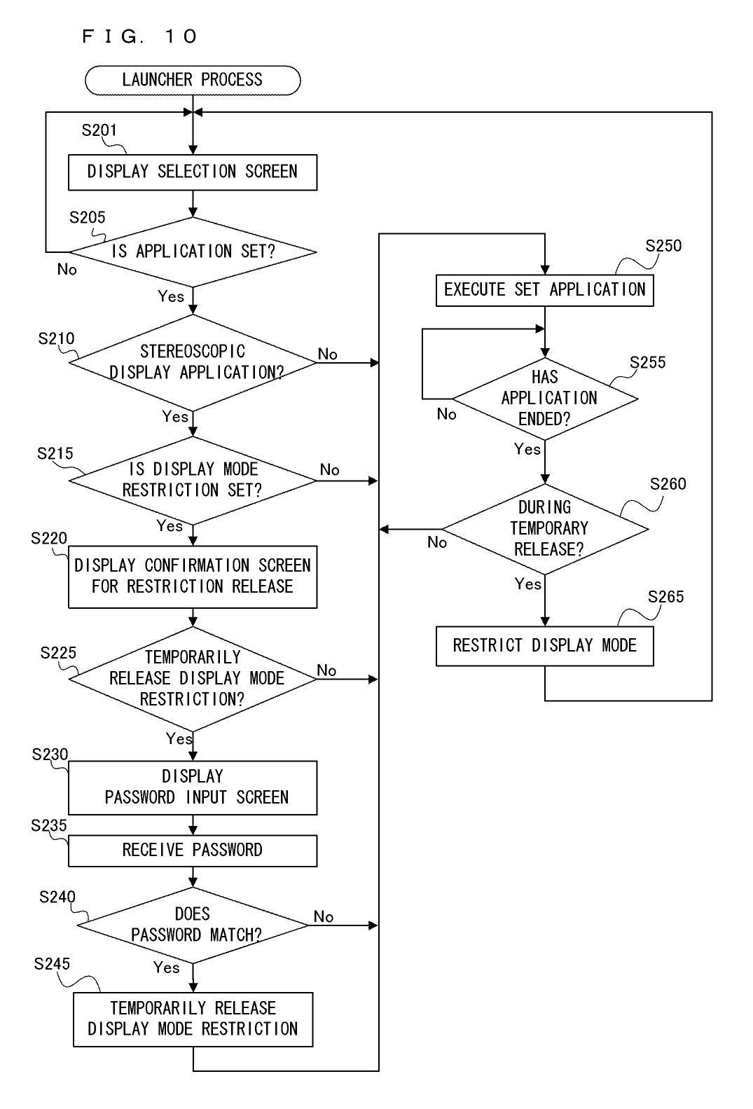

Next, processes performed by various programs being executed by the CPU 311 will be specifically described with reference to FIGS. 9 to 11. FIGS. 9 to 11 are flowcharts showing the processes performed by the various programs being executed by the CPU 311. In FIGS. 9 to 11, “step” is abbreviated as “S”.

[System Process]

FIG. 9 is a flowchart showing a system process performed by the CPU 311 executing the system program 603. The system process is automatically started by the CPU 311 when the system program 603 is loaded into the main memory 32.

When the system process is started, the CPU 311 initially performs an initial setting process (step 101). Specifically, the CPU 311 deletes all image data stored in the VRAM 313, updates the temporary release flag data 502 to be OFF, and deletes the reference virtual camera matrix 503 and the application virtual camera matrixes 504 stored in the main memory 32.

After performing the initial setting process, the CPU 311 determines whether or not a reference virtual camera matrix 503 is stored in the main memory 32 (step 105). More specifically, a reference virtual camera matrix 503 is generated by the CPU 311 executing an application program in parallel with the system program 603 as described above. In the process at step 105, the CPU 311 determines whether or not the reference virtual camera matrix 503 generated thus is stored in the main memory 32. When the reference virtual camera matrix 503 is not stored (No at step 105), the CPU 311 waits until the reference virtual camera matrix 503 is stored in the main memory 32.

On the other hand, when the reference virtual camera matrix 503 is stored (Yes at step 105), the CPU 311 determines whether or not restriction to only the planar display mode is temporarily released (step 110). Specifically, the CPU 311 refers to the temporary release flag data 502 stored in the main memory 32. When the temporary release flag data 502 represents ON, the CPU 311 determines that the restriction to only the planar display mode is temporarily released (Yes at step 110). On the other hand, when the temporary release flag data 502 represents OFF, the CPU 311 determines that the restriction to only the planar display mode is not temporarily released (No at step 110).

When determining that the restriction to only the planar display mode is not temporarily released (No at step 110), the CPU 311 determines whether or not restriction to the planar display mode is set (step 115). Specifically, the CPU 311 refers to the display mode restriction flag data 701 stored in the internal data storage memory 35. When the display mode restriction flag data 701 represents ON, the CPU 311 determines that the display mode is restricted to the planar display mode (Yes at step 115). On the other hand, when the display mode restriction flag data 701 represents OFF, the CPU 311 determines that restriction to the planar display mode is not set (No at step 115).

When determining that restriction to the planar display mode is not set (No at step 115), the CPU 311 obtains, as a stereoscopic view adjustment value, an analog value outputted from the 3D adjustment switch 25 as described above (step 120). In addition, when determining that the restriction to the planar display mode is temporarily released (Yes at step 110), the CPU 311 skips the process at step 115 and obtains a stereoscopic view adjustment value (step 120).

After obtaining the stereoscopic view adjustment value, the CPU 311 determines whether or not switching to the stereoscopic display mode by using the 3D adjustment switch 25 is set, on the basis of the obtained stereoscopic view adjustment value (step 125). Specifically, the CPU 311 determines whether or not the slider 25a is located at the third position, on the basis of the obtained stereoscopic view adjustment value. When the slider 25a is located at the third position, the CPU 311 determines that switching to the stereoscopic display mode is not set (switching to the planar display mode has been performed (No at step 125). On the other hand, when determining that the slider 25a is located at any position between the first position and the second position, the CPU 311 determines that switching to the stereoscopic display mode is set (Yes at step 125).

When determining that switching to the stereoscopic display mode is set (No at step 125), the CPU 311 determines whether or not the parallax barrier is turned off (step130). When determining that the parallax barrier is not turned off (No at step 130), the CPU 311 controls the LCD controller to turn off the parallax barrier (step 135). Then, even when the parallax barrier is turned off, the CPU 311 controls the LCD controller to provide a predetermined brightness which is substantially the same as a brightness visually recognized by the user when the parallax barrier is turned on (step 140). As described above, in the present embodiment, when restriction to the planar display mode is set (Yes at step 115) or when switching to the stereoscopic display mode is not set (No at step 125), and when the parallax barrier is not turned off (No at step 130), the parallax barrier is turned off (step 135) and the brightness is decreased (step140). In other words, when a planar image is displayed on the upper LCD 22, the CPU 311 turns off the parallax barrier and decreases the brightness, whereby power saving can be achieved while the brightness visually recognized by the user is maintained as described above.

When determining that switching to the stereoscopic display mode is set (Yes at step 125), the CPU 311 calculates and generates application virtual camera matrixes 504 (step 150). Specifically, the CPU 311 calculates the application virtual camera matrixes 504 on the basis of the reference virtual camera matrix 503 obtained at step 105 and the stereoscopic view adjustment value obtained at step 120. The application virtual camera matrixes 504 calculated in this case are calculated by such a predetermined method that the stereoscopic view adjustment value obtained at step 120 is reflected in a stereoscopic image which is generated such that an image of a virtual space which is taken with the reference virtual camera at the position and in the orientation which are indicated by the reference virtual camera matrix 503 can be stereoscopically viewed. In addition, what are indicated by the application virtual camera matrixes 504 calculated in this case are information for setting at least the positions and orientations of the left and right virtual cameras in the virtual space as described above.

Meanwhile, when turning off the parallax barrier and decreasing the brightness (step 135 and step 140), the CPU 311 calculates and generates restricted application virtual camera matrixes 504 (step 145). In addition, when the parallax barrier is turned off (Yes at step 130), the CPU 311 calculates and generates restricted application virtual camera matrixes 504 (step 145). Specifically, the CPU 311 calculates the application virtual camera matrixes 504 on the basis of the reference virtual camera matrix 503 obtained at step 105 and the stereoscopic view adjustment value obtained at step 120. The application virtual camera matrixes 504 calculated in this case are restricted so as to be information for setting the positions and orientations of the left and right virtual cameras to be the same as the position and orientation of the reference virtual camera which are indicated by the reference virtual camera matrix 503.

After calculating the application virtual camera matrixes 504 at step 145 or step 150, the CPU 311 stores the calculated application virtual camera matrixes 504 in the main memory 32 (step 155). Then, the CPU 311 deletes the reference virtual camera matrix 503 stored in the main memory 32 (step 160). Due to this, the CPU 311 can calculate new application virtual camera matrixes 504 on the basis of a new reference virtual camera matrix 503 which is generated by executing the application program.

Next, the CPU 311 determines whether or not an image generated by executing the application program is rendered by the VRAM 313 (step 165). When determining that the image is rendered by the VRAM 313 (Yes at step 165), the CPU 311 further determines whether or not the rendered image is images for both eyes (both an image for a left eye and an image for a right eye) (step 170).

When determining that the images for both eyes are rendered (Yes at step 170), the CPU 311 determines whether or not setting of restriction to the planar display mode is temporarily released (step 175). Specifically, the CPU 311 refers to the temporary release flag data 502 stored in the main memory 32. When the temporary release flag data 502 stored in the main memory 32 represents ON, the CPU 311 determines that the setting of the restriction to the planar display mode is temporarily released (Yes at step 175). On the other hand, when the temporary release flag data 502 stored in the main memory 32 represents OFF, the CPU 311 determines that the restriction to the planar display mode is not temporarily released, namely, the restriction to the planar display mode is set (No at step 175).

When the restriction to the planar display mode is temporarily released (Yes at step 175), the CPU 311 lights up the 3D indicator 26 (step 180). Due to this, the CPU 311 can notify that the images for both eyes are rendered by the VRAM 313 and it is in a state where a stereoscopic image can be displayed, by lighting up the 3D indicator 26. Then, the CPU 311 outputs the images for both eyes which are rendered by the VRAM 313 to the upper LCD 22 (step 185).

On the other hand, when determining that images for both eyes are not rendered (No at step 170), the CPU 311 turns off the 3D indicator 26 (step 190). Due to this, the CPU 311 can notify that images for both eyes are not rendered by the VRAM 313 and it is in a state where a stereoscopic image cannot be displayed, by turning off the 3D indicator 26. Then, the CPU 311 outputs the single image rendered by the VRAM 313 to the upper LCD 22 (step 195).

It is noted that in the process at step 185 or step 195, when the image is outputted to the upper LCD 22, if an image to be outputted to the lower LCD 12 is rendered by the VRAM 313, the CPU 311 also outputs the image to the lower LCD 12.

After outputting the image rendered by the VRAM 313, the CPU 311 repeats the processes from step 105. In addition, when determining that no image is rendered by the VRAM 313 (No at step 165), the CPU 311 does not output any image, and repeats the processes from step 105. This is the description regarding the system process performed by the CPU 311 according to the present embodiment.

[Launcher Process]

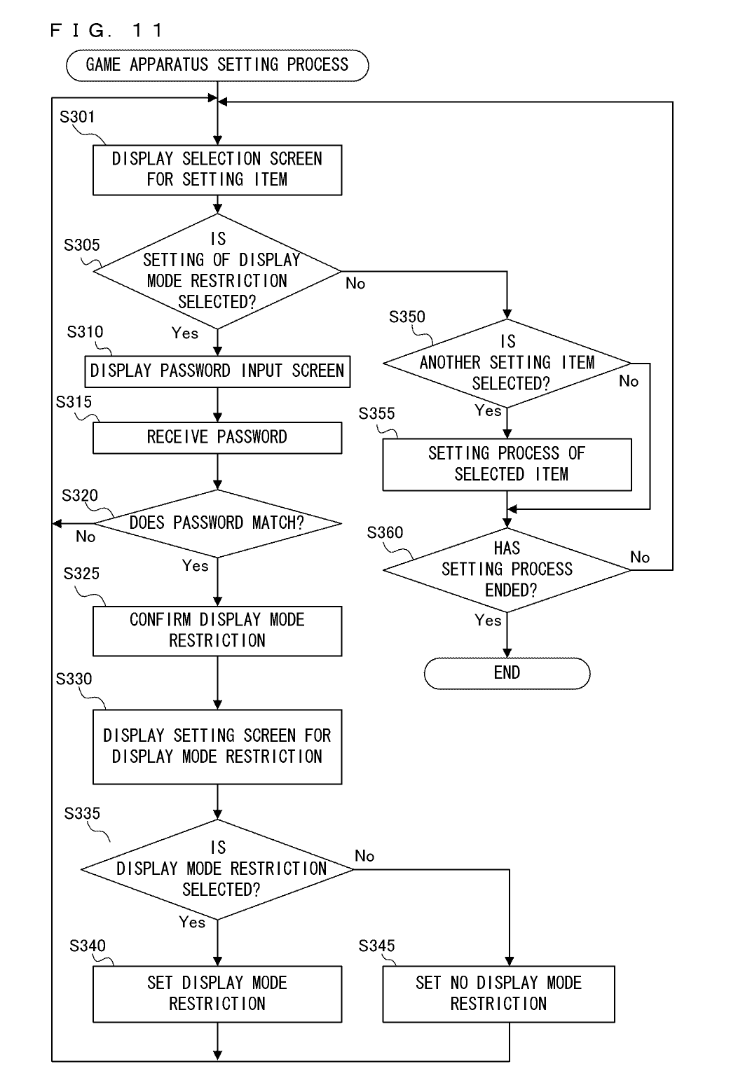

FIG. 10 is a flowchart showing a launcher process performed by the CPU 311 executing the launcher program 604. The launcher process is automatically started after the system process is started by the CPU 311.

When the launcher process is started, the CPU 311 initially displays a screen (hereinafter, referred to as selection screen) for causing the user to select an application program as described above (step 201). When displaying the selection screen, the CPU 311 performs a process of sliding an icon sequence in accordance with a selection operation of the user, a process of displaying content information of an application program which has become a selected state, and the like, as described above, on the basis of the touch position data 501. Then, an image generated by this process is rendered by the VRAM 313, and is outputted to the upper LCD 22 in accordance with setting of the display mode restriction by the CPU 311 executing the above-described system process in parallel. For example, when the content information of the application program in the selected state is information indicating a content of this program as a stereoscopic image, the stereoscopic image is restricted to a planar image or displayed on the upper LCD 22 as it is without being restricted, in accordance with the setting of the display mode restriction. In addition, when an image to be outputted to the lower LCD 12 is rendered by the VRAM 313 at this time, the image is outputted to the lower LCD 12 as well.

Such generation of an image to be displayed on the screen for the launcher process in accordance with an operation of the user is performed similarly for another screen described later (e.g., a confirmation screen for control release).

When displaying the selection screen, the CPU 311 determines whether or not execution of any application program is set as described above, on the basis of the touch position data 501 (step 205). When no application program to be executed is set (No at step 205), the CPU 311 returns to step 201 and continuously performs the process for displaying the selection screen.

On the other hand, when an application program is set (Yes at step 205), the CPU 311 determines whether or not the set application program is a program including a process of generating a stereoscopic image (step 210). Specifically, the CPU 311 refers to the stereoscopic display flag data 621 included in the set application program, and determines whether the stereoscopic display flag data 621 represents ON or OFF. When the referred stereoscopic display flag data 621 represents ON, the CPU 311 determines that the set program is a program including a process of generating a stereoscopic image (Yes at step 210). On the other hand, when the referred stereoscopic display flag data 621 represents OFF, the CPU 311 determines that the set program is a program which does not include a process of generating a stereoscopic image (No at step 210).

When determining that the set application program is a program which does not include a process of generating a stereoscopic image (No at step 210), the CPU 311 executes the set program (step 250).

On the other hand, when determining that the set application program includes a process of generating a stereoscopic image (Yes at step 210), the CPU 311 determines whether or not the display mode is restricted to only the planar display mode (step 215). Specifically, the CPU 311 refers to the display mode restriction flag data 701 stored in the internal data storage memory 35. When the display mode restriction flag data 701 represents ON, the CPU 311 determines that the display mode is restricted to the planar display mode (Yes at step 215). On the other hand, when the display mode restriction flag data 701 represents OFF, the CPU 311 determines that restriction to the planar display mode is not set (No at step 215).

When determining that it is not restricted to the planar display mode (No at step 215), the CPU 311 executes the set application program (step 250).

When determining that it is restricted to the planar display mode (Yes at step 215), the CPU 311 displays a screen (hereinafter, referred to as confirmation screen) for confirming whether or not to release the restriction to only the planar display mode as described above, prior to execution of the set application program (step 220).

Then, when displaying the confirmation screen, the CPU 311 determines whether or not it is selected to release the restriction to only the planar display mode, on the basis of the touch position data 501 (step 225). It is noted that the release of the restriction which is selected at this time is temporary release as described above.

When determining that it is not selected to release the restriction to the planar display mode (No at step 225), the CPU 311 maintains the setting of the restriction to the planar display mode and executes the application program which is set to be executed (step 250).

On the other hand, when determining that it is selected to release the restriction to only the planar display mode (Yes at step 225), the CPU 311 displays a password input screen for performing authentication for releasing the restriction (step 230). Then, the CPU 311 performs reception of a password as described above, on the basis of the touch position data 501 (step 235).

Upon reception of a password, the CPU 311 determines whether or not the received password matches a predetermined password (step 240). Specifically, the CPU 311 determines whether or not the received password matches the password indicated by the password data 702. When the received password matches the password indicated by the password data 702, the CPU 311 determines that a password which matches the predetermined password is received (Yes at step 240). On the other hand, when the received password does not match the password indicated by the password data 702, the CPU 311 determines that a password which does not match the predetermined password is received (No at step 240).

When determining that the received password does not match the predetermined password (No at step 240), the CPU 311 determines that the display mode restriction cannot be temporarily released, maintains the restriction to the planar display mode, and executes the application program which is set to be executed (step 250).

When determining that a password which matches the predetermined password is received (Yes at step 240), the CPU 311 releases the restriction to the planar display mode (step 245). Specifically, the CPU 311 updates the temporary release flag data 502 to be ON.

When releasing the restriction to the planar display mode, the CPU 311 executes the application program which is set to be executed (step 250). More specifically, the CPU 311 executes an application process performed by the set application program, in parallel with the launcher process. It is noted that execution of the set application program is started as described above, and an image generated by the CPU 311 executing the application program is rendered by the VRAM 313 and is outputted to the upper LCD 22 in accordance with setting of the display mode restriction by the CPU 311 performing the above system process in parallel. In addition, when an image to be outputted to the lower LCD 12 is rendered by the VRAM 313 at this time, the image is outputted to the lower LCD 12 as well.

When executing the application program, the CPU 311 determines whether or not the executed application program has ended, on the basis of an executed state of the application program (step 255). When determining that the application program has not ended (No at step 255), the CPU 311 waits until the application program is ended.

On the other hand, when determining that the application program is ended (Yes at step 255), the CPU 311 determines whether or not restriction to the planar display mode is temporarily released (step 260). Specifically, the CPU 311 refers to the temporary release flag data 502, and determines whether the temporary release flag data 502 represents On or OFF. When the temporary release flag data 502 represents On, the CPU 311 determines that the restriction to the planar display mode is temporarily released (Yes step 260). On the other hand, when the temporary release flag data 502 represents OFF, the CPU 311 determines that the restriction to the planar display mode is not temporarily released (No at step 260).

When determining that the restriction to the planar display mode is temporarily released (Yes at step 265), the CPU 311 restarts the temporarily released restriction to the planar display mode (step 265). Specifically, the CPU 311 updates the temporary release flag data 502 such that the temporary release flag data 502 represents OFF. When restarting the restriction to the planar display mode, the CPU 311 repeats the launcher process from step 201.

On the other hand, when determining that the restriction to the planar display mode is not temporarily released (No at step 265), the CPU 311 repeats the launcher process. This is the description regarding the launcher process performed by the CPU 311 according to the present embodiment.

[Game Apparatus Setting Process]

FIG. 11 is a flowchart showing a game apparatus setting process performed by the CPU 311 executing the game apparatus setting program 602. After the launcher process is started by the CPU 311 and then an application program to be executed is set in accordance with an operation of the user, the game apparatus setting process is executed (step 250).

When the game apparatus setting process is started, the CPU 311 initially displays the above-described selection screen for setting item (step 301). After displaying the selection screen for setting item, the CPU 311 determines whether or not the setting item of the display mode restriction is selected, on the basis of the touch position data 501 as described above (step 305).

When determining that the setting item of the display mode restriction is selected (Yes at step 305), the CPU 311 displays a password input screen as described above (step 310). Then, the CPU 311 performs reception of a password as described above, on the basis of the touch position data 501 (step 315).

Upon reception of a password, the CPU 311 determines whether or not the received password matches a predetermined password (step 320). The specific content of the process at step 320 is the same as that at step 235.

When determining that the received password does not match the predetermined password (No at step 320), the CPU 311 determines that the current user is a user who is not authorized to set the display mode restriction. In this case, the CPU 311 repeats the game apparatus setting process from the beginning without displaying a setting screen for display mode restriction.

On the other hand, when a password which matches the predetermined password is received (Yes at step 320), the CPU 311 confirms the current setting of the display mode restriction (step 325). Specifically, the CPU 311 confirms whether the display mode restriction flag data 701 represents ON or OFF.

When confirming the current setting of the display mode restriction, the CPU 311 displays the setting screen for display mode restriction as described above (step 330). In this case, as described above, the CPU 311 highlights either a button indicating “activate display mode restriction” or a button indicating “inactivate display mode restriction”, in order that the user can visually recognize the setting of the display mode restriction which is confirmed at step 325.

When displaying the setting screen for display mode restriction, the CPU 311 determines whether or not the display mode restriction is selected as described above, on the basis of the touch position data 501 (step 335). When determining that the display mode restriction is selected (Yes at step 335), the CPU 311 restricts the display mode restriction to the planar display mode (step 340). Specifically, the CPU 311 updates the display mode restriction flag data 701 such that the display mode restriction flag data 701 represents ON.

On the other hand, when no display mode restriction is selected (No at step 335), the CPU 311 sets no display mode restriction (step 345). Specifically, the CPU 311 updates the display mode restriction flag data 701 such that the display mode restriction flag data 701 represents OFF.

When performing setting of the display mode restriction in the process at step 340 or step 345, the CPU 311 ends the process for setting the display mode restriction and repeats the processes from the display of the selection screen for setting item (step 301).

In addition, when determining that the setting item of the display mode restriction is not selected (No at step 305), the CPU 311 determines whether or not any other setting item is selected as described above, on the basis of the touch position data 501 (step 350). Here, any other setting item is, for example, an item indicating setting of the current time or an item indicating setting of the user name (e.g., the name of the owner of the game apparatus 10).

When determining that any other setting item is selected (Yes at step 350), the CPU 311 executes a predetermined process which is to be executed when this setting item is selected (step 355). The specific process content is a conventionally-known optional process for setting the selected item, and thus the detailed description thereof is omitted.

On the other hand, when determining that none of the other setting items is selected (NO step 350), the CPU 311 determines whether or not end of the game apparatus setting process is selected as described above, on the basis of the touch position data 501 (step 360). In addition, when determining that none of the other setting items is selected (NO step 350), the CPU 311 similarly determines whether or not the end of the game apparatus setting process is selected.

When determining that the end of the game apparatus setting process is not selected (No at step 360), the CPU 311 repeats the processes from the display of the selection screen for setting item (step 301). On the other hand, when the end of the game apparatus setting process is selected (Yes at step 360), the CPU 311 ends the game apparatus setting process.

It is noted that when ending the game apparatus setting process, the CPU 311 determines that the game apparatus setting program 602 is ended as the application program at step 255 in the launcher process, and advances the launcher process. This is the specific description regarding the processes performed by the CPU 311 according to the present embodiment.

As described above, in the game apparatus 10 according to the present embodiment, when a stereoscopic image is displayed on the upper LCD 22, the stereoscopic image is restricted to a planar image and displayed on the basis of the setting of the display mode restriction. Due to this, a display of an inappropriate stereoscopic image (stereoscopic display) can be restricted to a display of a planar image (planar-view display).

Further, in the above description, the application program and the system program are separate programs independent from each other. However, in another embodiment, a part of the process by the application program may be a process by the system program. Similarly, in another embodiment, a part of the process by the system program may be a process by the application program. As a specific example, a part of the process by the system program is a part of the process by a library which can be incorporated into the application program. Here, the library is, for example, a set of program codes for causing the CPU 311 to execute general-purpose respective processes common in processes by various programs such as the aforementioned launcher program and game program.

Further, in another embodiment, processes which are the same as all the processes performed by the CPU 311 executing the application program and the system program in parallel may be performed by causing the CPU 311 to execute one program.

Further, in the above description, the game apparatus setting program causes the CPU 311 to execute management of the game apparatus information (display mode restriction flag data 701) indicating the setting of the display mode restriction. In addition, the launcher program causes the CPU 311 to execute management of the data (temporary release flag data 502) indicating setting of temporary release of the display mode restriction. However, in another embodiment, the launcher program may cause the CPU 311 to execute setting of the display mode restriction and management of restriction information based on setting of temporary release, independently of the game apparatus information indicating the setting of the display mode restriction. In addition, the system program may refer to the restriction information which the launcher program causes the CPU 311 to mange, and may cause the CPU 311 to execute a process of executing output of an image to the upper LCD 22.

Here, the restriction information is managed on the basis of the setting of the display mode restriction which is indicated by the game apparatus information, and the setting of temporary release. More specifically, when restriction to the planar display mode is indicated by the game apparatus information and temporary release is not set, the restriction to the planar display mode is indicated by the restriction information. In addition, when restriction to the planar display mode is indicated by the game apparatus information and temporary release is set, it is indicated by the restriction information that there is no restriction to the planar display mode. Moreover, when restriction to the planar display mode is not indicated by the game apparatus information, temporary release is not set, and thus it is indicated by the restriction information that there is no restriction to the planar display mode.

Then, when restriction to the planar display mode is indicated by the restriction information, the system program causes the CPU 311 to execute a process of restricting an image, which is to be displayed on the upper LCD 22, to a planar image as described above. On the other hand, when restriction to the planar display mode is not indicated by the restriction information, the system program causes the CPU 311 to execute a process of outputting a stereoscopic image or planar image rendered by the VRAM 313 as it is without restricting an image which is to be displayed on the upper LCD 22.

Further, the restriction information is not limited to information based on the setting of the display mode restriction which is indicated by the game apparatus information, and the setting of temporary release. For example, the restriction information may be managed such that the restriction information is updated directly in accordance with an operation of the user for setting the display mode restriction or an operation of the user for setting temporary release, each time the operation is performed.

Further, in the above description, a parallax barrier type liquid crystal display device can be used as the upper LCD 22, and switching between stereoscopic display and planar display can be performed by controlling ON/OFF of the parallax barrier. In another embodiment, for example, a lenticular lens type liquid crystal display device may be used as the upper LCD 22 so as to enable a stereoscopic image and a planar image to be displayed. In the case of a lenticular lens type as well, an image is stereoscopically displayed by vertically dividing two images taken with the outer imaging section 23 into rectangular portions and alternately arranging the rectangular portions. In addition, in the case of a lenticular lens type as well, by causing one image taken with the inner imaging section 24 to be viewed with the left and right eyes of the user, the image can be displayed as a planar image. In other words, even with the lenticular lens type liquid crystal display device, by vertically dividing the same images into rectangular portions and alternately arranging these rectangular portions, the same images can be caused to be viewed with the left and right eyes of the user. Due to this, it is possible to display, as a planar image, an image taken with the inner imaging section 24. However, when a lenticular lens type liquid crystal display device is used, there is no need to control ON/OFF of a parallax barrier and to turn off the parallax barrier and decrease the brightness for achieving power saving, as described above.

Further, in the above description, the lower LCD 12 and the upper LCD 22 physically separated from each other are arranged one above the other (the case of two screens above and below) as an example of an LCD display section having two screens. However, the configuration of the display screen of two screens may be another configuration. For example, the lower LCD 12 and the upper LCD 22 may be arranged on a main surface of the lower housing 11 laterally side by side. Alternatively, a vertically long LCD having the same width as that of the lower LCD 12 and a vertical length which is twice as large as that of the lower LCD 12 (namely, an LCD which is a physically single unit and has a display size with a vertical length equal to a sum of vertical lengths of two screens) may be provided in the main surface of the lower housing 11, and two images (e.g., a taken image, an image representing an operation explanation screen, etc.) may be displayed one above the other (displayed so as to be adjacent to each other without a boundary portion between above and below). Still alternatively, a horizontally long LCD having the same vertical length as that of the lower LCD 12 and a width which is twice as large as that of the lower LCD 12 may be provided in the main surface of the lower housing 11, and two images may be displayed laterally side by side (displayed so as to be adjacent to each other without a boundary portion between left and right). In other words, a physically single screen may be divided into two and used to display two images. Alternatively, in the case where the physically single screen is divided into two and used to display the two images, the touch panel 13 may be provided on the entirety of the screen.

Further, in the above description, the touch panel 13 is provided integrally to the game apparatus 10. However, it is understood that the embodiments can be realized even if the game apparatus and the touch panel are separately provided. In addition, the touch panel 13 may be provided on the upper LCD 22, the aforementioned display image displayed on the lower LCD 12 may be displayed on the upper LCD 22, and the aforementioned display image displayed on the upper LCD 22 may be displayed on the lower LCD 12.

Further, in the above description, the case where the hand-held game apparatus 10 is used has been described. However, the embodiments may be realized by an information processing apparatus, such as a general personal computer, executing the image processing program of the embodiments. In addition, in another embodiment, instead of the game apparatus, any hand-held electronic apparatus such as a PDA (Personal Digital Assistant), a mobile phone, a personal computer, or a camera may be used. For example, a mobile phone may include two display sections and a real camera in a principal surface of one housing.

Further, the shape of the game apparatus 10 described above, and the shapes, the numbers, the installed positions, and the like of the various operation buttons 14, the analog stick 15, and the touch panel 13 provided in the game apparatus 10, are merely an example. It is understood that the embodiments can be realized with other shapes, numbers, and installed positions. In addition, the order of steps, setting values, values for the determinations, and the like used in the aforementioned display control process are merely an example. It is understood that the embodiments can be realized with other orders and values.

Further, instead of supplying each of all the programs described above to the game apparatus 10 via an storage medium such as the internal data storage memory 35, the external memory 45, or the external data storage memory 46, all the programs described above may be supplied to the game apparatus 10 via a wired or wireless communication line and then may be executed. In addition, at least one of all the programs described above may previously be stored in a nonvolatile storage device in the game apparatus 10. It is noted that instead of a nonvolatile storage memory, a CD-ROM, a DVD, a similar optical disc storage medium, a flexible disc, a hard disc, an optical magnetic disc, a magnetic tape, or the like may be used as an information storage medium for storing at least one of all the programs described above. In addition, a volatile memory for temporarily storing a program may be used as an information storage medium for storing at least one of all the programs described above.

Further, in the above description, the example where all the programs described above are executed by the information processing section 31 (CPU 311) is used. However, at least one or at least some of all the programs described above may be executed by an information processing section which includes a CPU and is provided in another apparatus which can communicate with the information processing section 31. For example, when the game apparatus 10 is configured to be able to communicate with another apparatus (e.g., a server), the game apparatus 10 and the other apparatus may cooperate with each other to execute the processes in all the programs described above. As an example, all the programs described above may be executed in a system which is configured such that another apparatus executes the system program and the application program and the touch panel 13, the lower LCD 12, and the upper LCD 22 of the game apparatus 10 are used for detection of operations such as a touch-on, a touch-off, and a slide operation which are needed for execution of this program, a display device for displaying an image generated in accordance with execution of this program, and the like.

While the embodiments have been described in detail, the foregoing description is in all aspects illustrative and not restrictive. It is understood that numerous other modifications and variations can be devised without departing from the scope of the embodiments. It should be understood that the scope of the embodiments is interpreted only by the scope of the claims. It is also understood that, from the specific description of the embodiments, the one skilled in the art can easily implement the embodiments in the equivalent range based on the description of the embodiments and on the common technological knowledge. Further, it should be understood that terms used in the present specification have meanings generally used in the art concerned unless otherwise specified. Therefore, unless otherwise defined, all the jargon and technical terms have the same meanings as those generally understood by one skilled in the art of the embodiments. In the event of any conflict, the present specification (including meanings defined herein) has priority.

1. A computer-readable storage medium having stored therein an information processing program executed by a computer of a display control apparatus which displays an image on a display section in either of planar-view display or stereoscopic display, the information processing program causing the computer to operate as:
a switching section configured to switch a display setting which is a setting of whether to perform planar-view display or stereoscopic display by the display section, in accordance with an operation of a user;
a setter configured to set image display by the display section to a state of being restricted to the planar-view display or a state of not being restricted to the planar-view display; and
a display controller configured to switch the image display by the display section to the planar-view display or the stereoscopic display in accordance with the display setting which is set by the switching section, when the image display by the display section is set to the state of not being restricted to the planar-view display, and to cause the display section to perform planar-view display of an image regardless of the display setting which is set by the switching section, when the image display by the display section is set to the state of being restricted to only the planar-view display.

2. The computer-readable storage medium having stored therein the information processing program according to claim 1, wherein
the information processing program further causes the computer to operate as an input operation receiver configured to receive an operation input of the user via an input section, and
when an operation input which satisfies a predetermined condition is received by the input operation receiver, the setter sets the image display by the display section to the state of not being restricted to only the planar-view display.

3. The computer-readable storage medium having stored therein the information processing program according to claim 1, wherein
the information processing program is an information processing program which causes the display section to display an image which is generated by executing an application program which causes the computer to operate as an image generator configured to generate the image which is either a stereoscopic image which is stereoscopically viewable or a planar image which is not stereoscopically viewable, and
when the image display by the display section is set by the setter to the state of being restricted to only the planar-view display, the display controller restricts display of the image, which is generated by the image generator, by the display section, to the planar-view display regardless of the display setting by the switching section.

4. The computer-readable storage medium having stored therein the information processing program according to claim 1, wherein
the information processing program is an information processing program which causes the display section to display an image in accordance with a setting operation received by executing a setting operation reception program which causes the computer to operate as a receiver configured to receive, from the user, the setting operation for setting the image display by the display section to a state of being restricted to the planar-view display or a state of not being restricted to the planar-view display,
the switching section is capable of switching the display setting at all times, and
the setter sets the image display by the display section to the state of being restricted to the planar-view display or the state of not being restricted to the planar-view display, in accordance with the setting operation received by the receiver.

5. The computer-readable storage medium having stored therein the information processing program according to claim 1, wherein the switching section switches the display setting in accordance with an operation of the user on a mechanical switch.

6. The computer-readable storage medium having stored therein the information processing program according to claim 3, wherein
the image generator generates the stereoscopic image by using setting information indicating information for setting virtual cameras for taking the stereoscopic image composed of two images,
when the image display by the display section is set by the setter to the state of being restricted to only the planar-view display, the display controller generates the setting information for performing setting such that same images are generated by using the virtual cameras for taking the two images, respectively, regardless of the display setting by the switching section, and
the image generator generates the stereoscopic image composed of the same images, by using the setting information generated by the display controller.

7. The computer-readable storage medium having stored therein the information processing program according to claim 3, wherein
the image generator generates the stereoscopic image as two images having a disparity, and
when the image display by the display section is set by the setter to the state of being restricted to only the planar-view display, the display controller causes the display section to display only either one of the two images generated as the stereoscopic image.

8. The computer-readable storage medium having stored therein the information processing program according to claim 7, wherein
when two images having a disparity are generated as the stereoscopic image, the image generator generates images taken with left and right virtual cameras which are located in a virtual space at an interval corresponding to the disparity, and
when the image display by the display section is set by the setter to the state of being restricted to only the planar-view display, the display controller causes the display section to display the image taken with either one of the virtual cameras, among the two images generated as the stereoscopic image by using the left and right virtual cameras.

9. The computer-readable storage medium having stored therein the information processing program according to claim 3, wherein the image generator generates the stereoscopic image by using instruction information based on at least an instruction value outputted from an instruction section configured to instruct a stereoscopic degree at which the user visually recognizes a stereoscopic display object indicated by the stereoscopic image, as being stereoscopic.

10. The computer-readable storage medium having stored therein the information processing program according to claim 7, wherein
the image generator generates setting information for generating the stereoscopic image,
the information processing program further causes the computer to operate as an instruction value receiver configured to receive the instruction value outputted from the instruction section, and
the display controller generates the instruction information on the basis of the setting information and the instruction value received by the instruction value receiver.

11. The computer-readable storage medium having stored therein the information processing program according to claim 7, wherein
when two images having a disparity are generated as the stereoscopic image, the image generator generates images taken with left and right virtual cameras which are located in a virtual space at an interval corresponding to the disparity, and
when the image display by the display section is set by the setter to the state of being restricted to only the planar-view display, the display controller generates the instruction information including information for setting the interval between the left and right virtual cameras to zero, on the basis of the setting information and the instruction value which is outputted from the instruction section and converted so as to indicate a stereoscopic degree of zero.

12. The computer-readable storage medium having stored therein the information processing program according to claim 7, wherein the image generator generates the stereoscopic image in accordance with the instruction information based on at least the instruction value outputted from the instruction section which enables an analog input.

13. The computer-readable storage medium having stored therein the information processing program according to claim 2, wherein
the information processing program is an information processing program which causes the display section to display an image which is generated by executing an application program which causes the computer to operate as an image generator configured to generate the image which is either a stereoscopic image which is stereoscopically viewable or a planar image which is not stereoscopically viewable, and
when the image display by the display section is set by the setter to the state of being restricted to only the planar-view display, the input operation receiver receives an operation input of the user when execution of the application program is started, and
the information processing program further causes the computer to operate as:
a release section configured to release the setting of the image display by the display section to the state of being restricted to only the planar-view display, which setting is performed by the setter, when an operation input which satisfies the predetermined condition is received by the input operation receiver; and
a restriction returning section configured to return the setting released by the release section, when the execution of the application program ends.

14. The computer-readable storage medium having stored therein the information processing program according to claim 1, wherein
the information processing program is an information processing program which causes the display section to display a stereoscopic image which is generated by executing an application program which causes the computer to operate as an image generator configured to generate the stereoscopic image by generating stereoscopic degree information indicating a stereoscopic degree at which the user visually recognizes a stereoscopic display object indicated by the stereoscopic image which is stereoscopically viewable, as being stereoscopic,
the information processing program further causes the computer to operate as a setting information generator configured to generate setting information needed for generating the stereoscopic image by the image generator, on the basis of the stereoscopic degree information, and
the image generator generates the stereoscopic image by using the setting information.

15. The computer-readable storage medium having stored therein the information processing program according to claim 1, wherein
the information processing program further causes the computer to operate as a notification controller configured to control a notification section configured to notify that stereoscopic display by the display section is enabled, and
when the image display by the display section is set by the setter to the state of being restricted to only the planar-view display, the notification controller stops notification by the notification section regardless of whether or not the stereoscopic display is enabled, and when the image display by the display section is set by the setter to the state of not being restricted to only the planar-view display, the notification controller causes the notification section to perform notification if the stereoscopic display is enabled.

16. The computer-readable storage medium having stored therein the information processing program according to claim 1, wherein the information processing program further causes the computer to operate as a parallax barrier controller configured to turn off a parallax barrier used by the display section for performing stereoscopic display, when the image display by the display section is set by the setter to the state of being restricted to only the planar-view display.

17. An information processing method used in a display control apparatus which displays an image on a display section in accordance with switching by a switching section configured to receive from a user an operation for switching a display setting which is a setting of whether to perform planar-view display or stereoscopic display, the information processing method comprising:
a setting step of setting image display by the display section to a state of being restricted to the planar-view display or a state of not being restricted to the planar-view display; and
a display controlling step of switching the image display by the display section to the planar-view display or the stereoscopic display in accordance with the display setting which is set by the switching section, when the image display by the display section is set to the state of not being restricted to the planar-view display, and causing the display section to perform planar-view display of an image regardless of the display setting which is set by the switching section, when the image display by the display section is set to the state of being restricted to only the planar-view display.

18. An information processing apparatus comprising:
a display section configured to display an image in either planar-view display or stereoscopic display;
a switching section configured to switch a display setting which is a setting of whether to perform planar-view display or stereoscopic display by the display section, in accordance with an operation of a user;
a setter configured to set image display by the display section to a state of being restricted to the planar-view display or a state of not being restricted to the planar-view display; and
a display controller configured to switch the image display by the display section to the planar-view display or the stereoscopic display in accordance with the display setting which is set by the switching section, when the image display by the display section is set to the state of not being restricted to the planar-view display, and to cause the display section to perform planar-view display of an image regardless of the display setting which is set by the switching section, when the image display by the display section is set to the state of being restricted to only the planar-view display.

19. An information processing system comprising:
a display section configured to display an image in either planar-view display or stereoscopic display;
a switching section configured to switch a display setting which is a setting of whether to perform planar-view display or stereoscopic display by the display section, in accordance with an operation of a user;
a setter configured to set image display by the display section to a state of being restricted to the planar-view display or a state of not being restricted to the planar-view display; and
a display controller configured to switch the image display by the display section to the planar-view display or the stereoscopic display in accordance with the display setting which is set by the switching section, when the image display by the display section is set to the state of not being restricted to the planar-view display, and cause the display section to perform planar-view display of an image regardless of the display setting which is set by the switching section, when the image display by the display section is set to the state of being restricted to only the planar-view display.
